(19) United States
(12) Patent Application Publication
(10) Pub. No.: US 2011/0184682 A1
(43) Pub. Date: Jul. 28, 2011

(54) TERMINAL INSERTION DEFECT DETERMINING METHOD

(75) Inventor: Akinori Oishi, Mie (JP)

(73) Assignee: SUMITOMO WIRING SYSTEMS, LTD., Yokkaichi-shi, Mie (JP)

(21) Appl. No.: 12/996,019

(22) PCT Filed: Feb. 17, 2009
(86) PCT No.: PCT/JP2009/052606

§ 371 Date: Dec. 3, 2010

(30) Foreign Application Priority Data
Oct. 15, 2008 (JP) 2008-266283

(51) Int. Cl. G06F 19/00

(52) U.S. Cl. 702/82

(57) ABSTRACT

A terminal insertion defect determining method includes a step of determining the defect state by judging whether the preset condition is satisfied or not in an insulation-displacement period where an insulation-displacement part is insulation-displaced to a wire, a step of determining the defect state by judging whether the preset condition is satisfied or not in an intermediate period between the insulation-displacement period and a press-fitting period where a press-fitting part is press-fitted to a press-fitted part, and a step of determining the defect state by judging whether the preset condition is satisfied or not in the press-fitting period.

### BACKGROUND OF THE INVENTION

1. Field of the Invention

The present invention relates to a technique of inserting an insulation-displacement terminal.

2. Description of the Related Art

Japanese Patent Document Laid-Open No. S59-197192 discloses a technology of automatically inserting a terminal. Japanese Patent Document Laid-Open No. S59-197192 discloses the technology of inserting and fixing a pin terminal to a printed board.

### SUMMARY OF THE INVENTION

Meanwhile, a configuration including an electrical circuit body with an insertion hole in which a press-fitted part is formed and a wire laid out so as to go across the insertion hole, and including an insulation-displacement terminal with an insulation-displacement part to be insulation-displaced to the wire and a press-fitting part to be press-fitted to the press-fitted part after the insulation-displacement part is insulation-displaced to the wire, as an electrical circuit part, whereby the insulation-displacement terminal is inserted into the insertion hole, is proposed.

In the electrical circuit part mentioned above, when the insulation-displacement terminal is inserted to the insertion hole, it is necessary to confirm whether an insulation-displacement state of the insulation-displacement part and a press-fitting state of the press-fitting part is preferable or not. Therefore, it is an important problem to determine the state of the relevant terminal insertion accurately.

It is therefore an object of the present invention is to determine the state of the terminal insertion when an insulation-displacement terminal including an insulation-displacement part and a press-fitting part is inserted into an insertion hole.

In order to solve the above problem, according to a first aspect of the invention, a terminal insertion defect determining method determines an insertion defect of an insulation-displacement terminal including an insulation-displacement part to be insulation-displaced to a wire and a press-fitting part to be press-fitted to a press-fitted part after the insulation-displacement part is insulation-displaced to the wire, when the insulation-displacement terminal is inserted into an insertion hole with said press-fitted part formed therein, the insertion hole being provided on an electrical circuit body with the electric wire laid out so as to traverse the insertion hole, the method including (a) a step of judging whether a pressure in a insulation-displacement period where the insulation-displacement part is insulation-displaced to the wire satisfies the preset condition or not, and determining the defect state when judged not satisfying the condition, (b) a step of judging whether a pressure in an intermediate period between the insulation-displacement period and a press-fitting period where the press-fitting part is press fitted to the press-fitted part satisfies the preset condition, and determining the defect state when judged not satisfying the condition, and (c) a step of judging whether a pressure in the press-fitting period satisfies the preset condition, and determining the defect state when judged not satisfying the condition.

According to the first aspect of the terminal insertion defect determining method, suitable conditions can be set for each of the insulation-displacement period, the press-fitting period, and the intermediate period. The defect condition of the terminal insertion can be determined on the basis of the judging result of each period.

According to a second aspect of the invention, in the terminal insertion defect determining method according to the first aspect of the invention, in the step (a), whether a maximum value of the pressure in the insulation-displacement period satisfies the preset insulation-displacement period threshold value condition or not is judged, and the defect state is determined when judged not satisfying the insulation-displacement period threshold value condition, in the step (b), whether a minimum value of the pressure in the intermediate period satisfies the preset intermediate period threshold value conditions or not is judged, and the defect state is determined when judged not satisfying the intermediate period threshold value condition, and in the step (c), whether a maximum value of the pressure in the press-fitting period satisfies the preset press-fitting period threshold value condition or not is judged, and the defect state is determined when judged not satisfying the press-fitting period threshold value condition.

Meanwhile, in a preferable insertion, the pressure is larger in insulation-displacement, and also in press-fitting, but smaller in the intermediate therebetween. Thus, as the terminal insertion defect determining method according to the second aspect of the invention, by judging whether the preset threshold value condition in each period is satisfied or not by the maximum value in the insulation-displacement period, the maximum value in the press-fitting period, and the minimum value of the intermediate period, respectively, the defect state of the terminal insertion can be determined on the basis of the judging result of each period.

According to a third aspect of the invention, in the terminal insertion defect determining method according to the second aspect of the invention, an insulation-displacement period lower threshold value to be satisfied by the maximum value of the pressure in the insulation-displacement period is set as the insulation-displacement period threshold value condition in the step (a), an intermediate period upper threshold value to be satisfied by the minimum value of the pressure in the intermediate period is set as the intermediate period threshold value condition in the step (b), and a press-fitting period lower threshold value to be satisfied by the maximum value of the pressure in the press-fitting period is set as the press-fitting period threshold value condition in the step (c).

According to the third aspect of the invention, a pressure shortage in the insulation-displacement period, a pressure excess in the intermediate period, and a pressure shortage in the press-fitting period can be determined as the defect state of the terminal insertion, thereby determining the defect state of the terminal insertion more appropriately in accordance with the insertion characteristics of each period.

According to a fourth aspect of the invention, in the terminal insertion defect determining method according to the third aspect of the invention, in the step (a), when the maximum value of the pressure in the insulation-displacement period is judged not satisfying the insulation-displacement period lower threshold value, it is determined that wire or terminal is absent, in the step (b), when the minimum value of the pressure in the intermediate period is judged not satisfying the intermediate period upper threshold value, it is determined to be terminal displacement, and in the step (c), when the maximum value of the pressure in the press-fitting period is judged not satisfying the press-fitting period lower threshold value, it is determined to be a shortage of press-fitting.

According to the fourth aspect of the terminal insertion defect determining method, the defect state can be specified in each period on the basis of the judging result.

According to a fifth aspect of the invention, in the terminal insertion defect determining method according to the third aspect of the invention, the press-fitting period upper threshold value to be satisfied by the maximum value of the pressure in the press-fitting period is further set as the press-fitting period threshold value condition in the step (c).

According to the fifth aspect of the invention, the pressure shortage in the press-fitting period can be determined as a terminal insertion defect, thereby determining the defect state of the terminal insertion more appropriately.

According to a sixth aspect of the invention, in the terminal insertion defect determining method according to the fifth aspect of the invention, in said step (a), when the maximum value of the pressure in the insulation-displacement period is judged not satisfying the insulation-displacement period lower threshold value, it is determined that wire or terminal is absent, in the step (b), when the minimum value of the pressure in the intermediate period is judged not satisfying the intermediate period upper threshold value, it is determined to be terminal displacement, and in the step (c), when the maximum value of the pressure in the press-fitting period is judged not satisfying the press-fitting period lower threshold value, it is determined to be a shortage of press-fitting, and when the maximum value of the pressure in the press-fitting period is judged not satisfying the press-fitting period upper threshold value, it is determined to be an excess of press-fitting.

According to the sixth aspect of the terminal insertion defect determining method, the defect state can be specified in each period on the basis of the judging result.

According to a seventh aspect of the invention, the terminal insertion defect determining method according to the first to sixth aspects of the invention, further includes (d) a step of obtaining a timing, at which the maximum value of the pressure applied on the insulation-displacement terminal is produced in the insulation-displacement period, and judging whether the timing is in a period determined in accordance with displacement of the insulation-displacement terminal or not, determining an abnormal wire position when the timing is not in the period.

According to the seventh aspect of the terminal insertion defect determining method, by obtaining a timing where the maximum value of the pressure is produced in the insulation-displacement period, and judging whether this timing is in a period determined in accordance with displacement of the insulation-displacement terminal or not, the defect duet to the abnormal wire position can be specified.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a schematic plain view of showing an electric circuit body into which an insulation-displacement terminal is inserted.

FIG. 2 is a cross sectional view taken along the line II-II in FIG. 1;

FIG. 3 is a front view of the insulation-displacement terminal.

FIG. 4 is a schematic front view of an insulation-displacement terminal insertion device according to a first preferred embodiment.

FIG. 5 is a schematic side view of the insulation-displacement terminal insertion device according to the first preferred embodiment.

FIG. 6 is a hardware block diagram of a determining part according to the first preferred embodiment.

FIG. 7 is a functional block diagram of the determining part according to the first preferred embodiment.

FIG. 8 is a view of showing a pressure waveform when the insulation-displacement terminal is preferably inserted.

FIG. 9 is a flow chart of showing a defect determining process of a terminal insertion according to the first preferred embodiment.

FIG. 10 is a view of showing the pressure waveform when the defect state of the terminal insertion is absence of wire or terminal.

FIG. 11 is a view of showing the pressure waveform when the defect state of the terminal insertion is terminal displacement.

FIG. 12 is a view of showing the pressure waveform when the defect state of the terminal insertion is a shortage of press-fitting.

FIG. 13 is a view of showing the pressure waveform when the defect state of the terminal insertion is an excess of press-fitting.

FIG. 14 is a schematic front view of the insulation-displacement terminal insertion device according to a second preferred embodiment.

FIG. 15 is a view of showing that the height of the wire laid out on the electrical circuit body is different from each insertion hole.

FIG. 16 is a view of showing the height of the insulation-displacement when the insulation-displacement terminal is inserted into the insertion hole having different wire heights.

FIG. 17 is a view of showing the pressure waveform and the displacement waveform when the insulation-displacement terminal is actually inserted into the insertion hole with the wire laid out at the height of Ha.

FIG. 18 is a view of showing the pressure waveform and the displacement waveform when the insulation-displacement terminal is actually inserted into the insertion hole with the wire laid out at the height of Hc.

FIG. 19 is a view of showing a correspondence table of the displacement condition h1-h2 to the wire height H.

FIG. 20 is a flow chart of showing the defect determining process of the terminal insertion according to the second preferred embodiment.

### DETAILED DESCRIPTION OF THE PREFERRED EMBODIMENTS

### First Preferred Embodiment

Hereinafter, a terminal insertion defect determining method according to the first preferred embodiment will be described. Here, an example where the method is applied to an insulation-displacement terminal insertion device 60 will be described. The insulation-displacement terminal insertion device is a device for inserting an insulation-displacement terminal into an electrical circuit body through operations of provisional insertion and actual insertion.

<1. Description of Insulation-Displacement Terminal and Electrical Circuit Body>

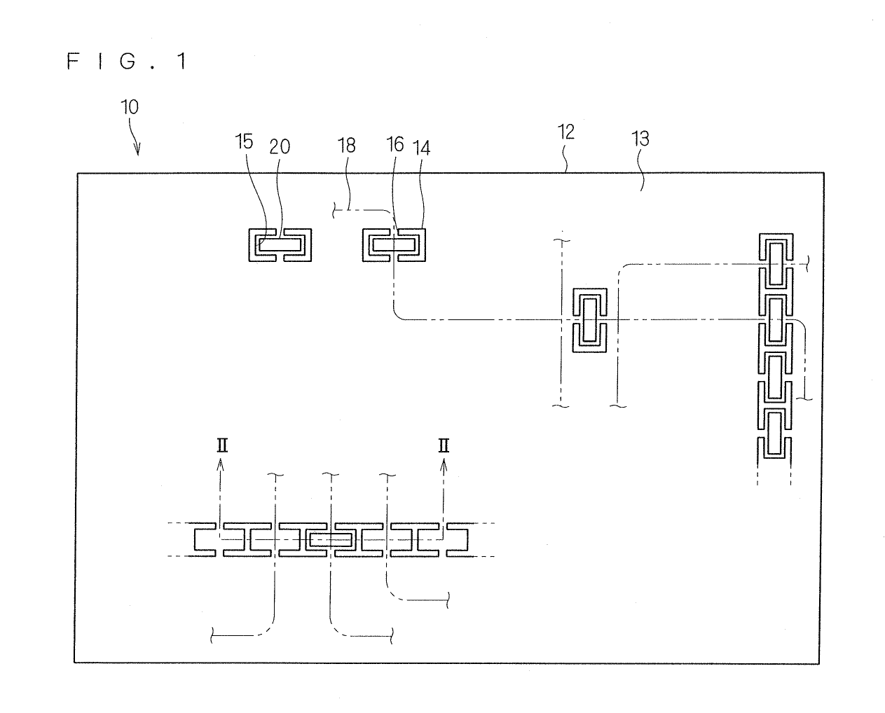

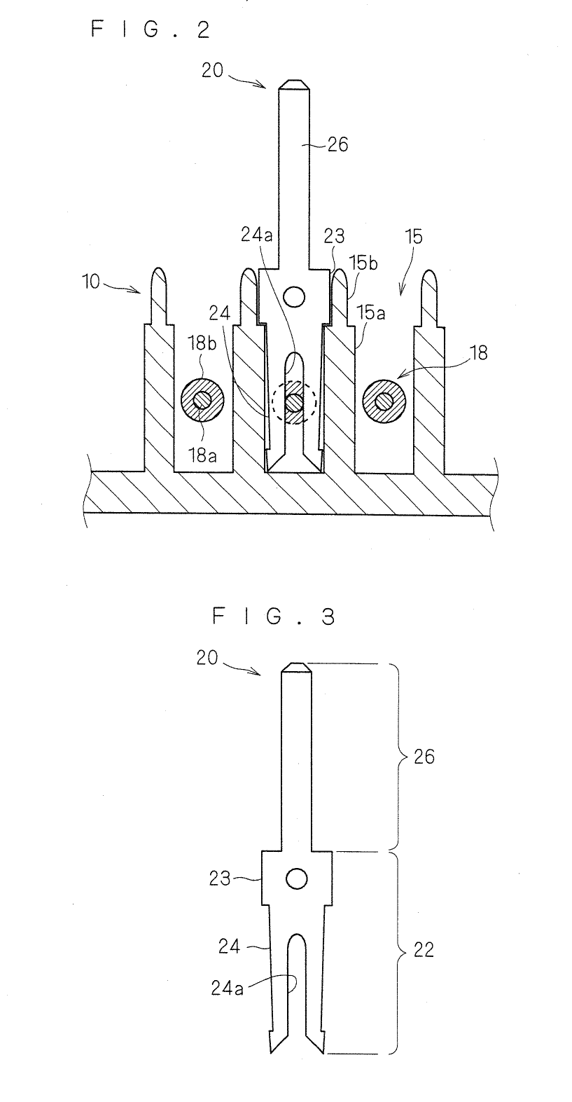

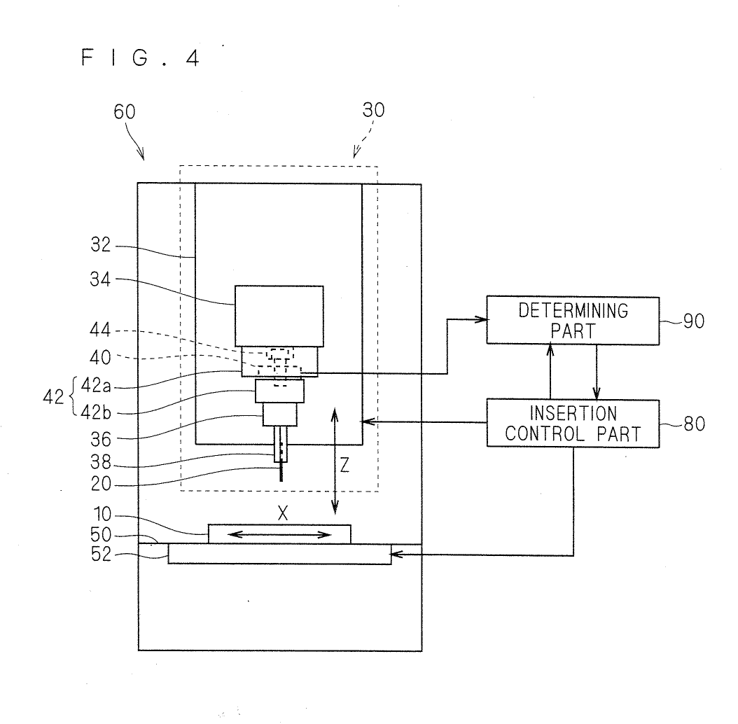

For convenience of explanation, an electrical circuit body 10 and an insulation-displacement terminal 20 to be an object will be described to begin with. FIG. 1 is a schematic plain view of showing the electrical circuit body 10 into which the insulation-displacement terminal 20 is inserted. FIG. 2 is a cross sectional view taken along the line II-II in FIG. 1, and FIG. 3 is a front view of the insulation-displacement terminal 20.

The electrical circuit body 10 includes a circuit assembling member 12 formed of an insulating material such as resin and the like, and a wire 18 laid out on the circuit assembling member 12 with a predetermined interconnecting pattern.

The circuit assembling member 12 includes a substantially rectangular plate-like member 13, and a plurality of protruding parts 14 formed to be protruded to one main surface of the plate-like member 13. An insertion hole 15 into which the insulation-displacement terminal 20 is inserted is formed on the protruding part 14, and in addition, a slit 16 to which the wire 18 is inserted and displaced is formed to extend from a top end to a bottom end of the protruding part 14. Further, a press-fitted part 15b is formed in an opening of the insertion hole 15, the press-fitted part 15b being wider than a back side part 15a thereof. The insulation-displacement terminal 20 is fixed and held with a predetermined position and posture by mainly being press-fitted to the press-fitted part 15b.

The wire 18 is configured such that a covering part 18b such as insulating resin and the like covers around a core wire 18a having conductivity, and is laid out on one main surface of the plate-like member 13 with a predetermined interconnecting pattern passing through the protruding part 14. The wire 18 is disposed so as to traverse the insertion hole 15 in a part passing through the protruding part 14 by being inserted and displaced in the slit 16.

The insulation-displacement terminal 20 is formed of a conductive plate such as a metal plate and the like, and is elongated plate-like in a manner that a connection part 26 and an insertion part 22 continue in a straight line.

The connection part 26 is formed in a shape to be connected to other connector terminals. Here, the connection part 26 may be formed in a shape to be connected to electrical parts such as a fuse, relay and the like other than connector terminals.

The insertion part 22 is a part inserted into the insertion hole 15, and includes a press-fitting part 23 formed at a side of the connection part 26 and a insulation-displacement part 24 formed at further end thereof.

The press-fitting part 23 is formed wider (slightly wider here) than width dimension of the press-fitted part 15b, and formed to be press-fitted to the press-fitted part 15b. The insulation-displacement part 24 has a substantially U-shape-slit-like insulation-displacement concave part 24a extending from a top end thereof to a bottom end. The width of the insulation-displacement concave part 24a is set to be smaller (slightly smaller here) than the diameter of the core wire 18a of the wire 18. An opening of the insulation-displacement concave part 24a is formed in a shape to be sequentially wider toward the opening direction. Then, when the wire 18 is pushed into the insulation-displacement concave part 24a, the insulation-displacement concave part 24a is cut into the covering part 18b, and finally, both edges of the insulation-displacement concave part 24a are in contact with the core wire 18a and electrically connected thereto. The width of the top end of the insulation-displacement part 24 is set to be almost same as the width of the back side part 15a of the insertion hole 15, or smaller (slightly smaller) than the width thereof. In addition, in a state where the insulation-displacement part 24 is inserted to the back side part 15a of the insertion hole 15, both edges of the insulation-displacement part 24 are in contact with the both side walls of the back side part 15a so as to suppress the insulation-displacement concave part 24a to be opened, thereby maintaining more certainly the electrical connection state between the insulation-displacement part 24 and the core wire 18a.

<2. Insulation-Displacement Terminal Insertion Device>

<2.1 Entire Configuration of Insulation-Displacement Terminal Insertion Device>

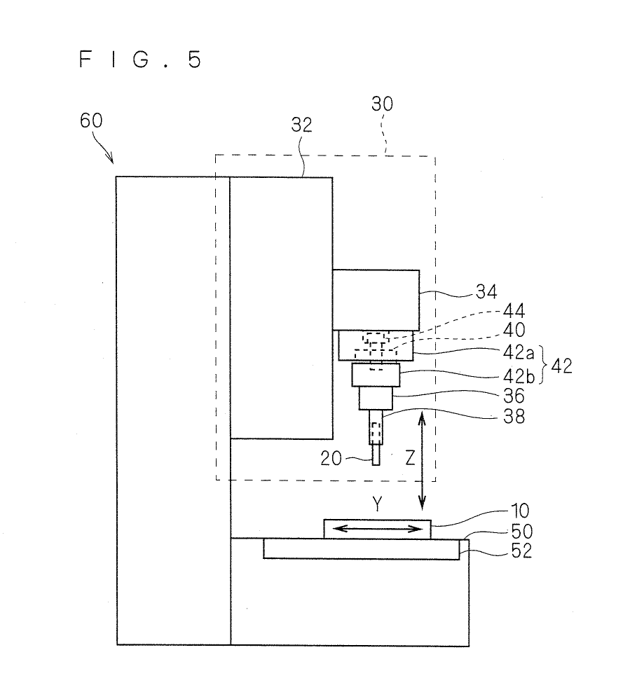

Next, the insulation-displacement terminal insertion device 60 will be described. FIG. 4 is a schematic front view of the insulation-displacement terminal insertion device 60, and FIG. 5 is a schematic side view of the insulation-displacement terminal insertion device 60.

Here, an X direction and a Y direction orthogonal thereto in FIGS. 4 and 5 are directions to define an operating plane of an X-Y stage 52 shown in Figures, and a Z direction is a direction in which the insulation-displacement terminal 20 is approaching to or spaced apart from the electrical circuit body 10 by a terminal insertion mechanism 30. The Z direction may be described using a vertical direction in accordance with the posture of the insulation-displacement terminal insertion device 60 in FIGS. 4 and 5. However, the direction is used for convenience of explanation, and does not restrict the posture and the operating direction of the insulation-displacement terminal insertion device 60.

The insulation-displacement terminal insertion device 60 includes the terminal insertion mechanism 30 by which the insulation-displacement terminal 20 is inserted into the electrical circuit body 10, and an electrical circuit body supporting part 50 for supporting the electrical circuit body 10.

The electrical circuit body supporting part 50 is configured to support the electrical circuit body 10 so as to be substantially horizontal. For instance, the electrical circuit body supporting part 50 is composed of a known supporting mechanism such as a holding mechanism or fitting mechanism. Further, the electrical circuit body supporting part 50 includes a common X-Y stage 52 composed of a plurality of linear actuators and the like, and holds the electrical circuit body 10 so as to be movable on an X-Y plane (substantially horizontal plane) shown in Figures. Then, the electrical circuit body supporting part 50 is configured such that the electrical circuit body 10 is movable so as to dispose any insertion hole 15 of the electrical circuit body 10 at a position almost immediately below a holding part 38 holding the insulation-displacement terminal 20 (ahead of an approaching direction).

The terminal insertion mechanism 30 includes a driving mechanism 32, an elevating part 34 to move up and down by the driving mechanism 32, and a head part 36 including the holding part 38 holding the insulation-displacement terminal 20.

The driving mechanism 32 is composed of a driving part and a transmission mechanism, which are not shown, and is configured such that the driving force of the driving part is transmitted by the transmission mechanism to the elevating part 34 as a force of moving the elevating part 34 up and down. Such a driving mechanism 32 may employ, for example, a configuration including a driving motor as the driving part, and the transmission mechanism including a cam converting a rotational movement of the driving motor to a linear reciprocation motion in a direction of moving up and down of the terminal insertion mechanism 30 so as to transmit to the elevating part 34. The elevating part 34 and the head part 36 supported thereby move up and down by driving this driving mechanism 32.

Here, the driving mechanism 32 is not limited to a configuration including the driving motor and the transmission mechanism such as a cam and the like, but may be configured such that the elevating part 34 is moved so as to come close to and be spaced apart from the electrical circuit body 10 along the Z direction. For instance, the elevating part 34 may be composed of an air cylinder, a hydraulic cylinder, a linear motor, and the like.

The elevating part 34 is supported by the driving mechanism 32 and the like so as to be able to move up and down, and is able to come close to and be spaced apart from the electrical circuit body 10 by driving the aforementioned driving mechanism 32.

Further, the elevating part 34 supports the head part 36 to be drooping to a lower end at a side of the electrical circuit body 10, and supports the head part 36 so as to be able to come close to and be spaced apart from the electrical circuit body 10 by elevating the elevating part 34. Then, the elevating part 34 is stopped and disposed at a top dead point being spaced apart from the electrical circuit body 10 (here, a position where the holding part 38 is disposed when the insulation-displacement terminal 20 is received) in its initial state, and is disposed at the position coming close to the electrical circuit body 10 (a position where the insulation-displacement terminal 20 held by the holding part 38 is inserted into the insertion hole 15) in a terminal insertion operation described later. This elevating part 34 incorporates a pressure sensor 40 for detecting pressure applied to the insulation-displacement terminal 20 in the terminal insertion. This will be described later.

The head part 36 is supported by the elevating part 34, and moved to come close to and to be spaced apart from the electrical circuit body 10 held by the X-Y stage 52 by the movement of the elevating part 34 in the Z direction. The head part 36 also has the holding part 38 capable of holding the insulation-displacement terminal 20 at its bottom end (lower side).

The holding part 38 has a pair of holding portions. One of the pair of the holding portions is capable of being opened and closed to the other. The holding part 38 is configured to be capable of holding and releasing the insulation-displacement terminal 20 between the pair of the holding portions by opening and closing one of the pair. More specifically, the holding part 38 is configured to be able to hold the insulation-displacement terminal 20 to be interposed between the pair of the holding portions with the posture such that the insertion part 22 of the insulation-displacement terminal 20 looks down (a side of the electrical circuit body 10) and at the same time, plane direction of the insulation-displacement terminal 20 is substantially parallel to the Y direction. Further, the holding part 38 is configured to hold the insulation-displacement terminal 20 at the start of provisional insertion and actual insertion described later, and release at the completion of the provisional insertion and actual insertion.

The aforementioned driving mechanism with one of the holding portions being opened and closed may employ, for example, a configuration of transmitting rotational movement of a motor as a force of operating one of the holding portions to be opened and closed by the transmission mechanism including a cam. The driving mechanism may be configured to be incorporated to the holding part 38 itself, or may be configured to be provided outside the holding part 38, operating one of the holding portions by pressing from outside. In the latter case, the motor of the driving mechanism 32 may be used. Further, the driving mechanism with one of the holding portions being opened and closed may employ a configuration of using an air cylinder, a hydraulic cylinder, an electromagnetic actuator, and the like other than the above.

The aforementioned holding part 38 is configured to be able to hold the press-fitting part 23 of the insulation-displacement terminal 20 so as to be interposed between the pair of the holding portions at the time of the provisional insertion, and is configured to be able to hold the connection part 26 of the insulation-displacement terminal 20 (here, a portion closer to a side of the connection part 26 than a boundary between the connection part 26 and the press-fitting part 23) such that the insulation-displacement part 24 and the press-fitting part 23 of the insulation-displacement terminal 20 are completely inserted, at the time of the actual insertion.

This holding part 38 is stopped and disposed at an upper position where the insulation-displacement terminal 20 supplied by a terminal feeding device and the like not shown is to be received, in its initial state, with one of the holding portions being opened. In this state, when the insulation-displacement terminal 20 is fed between the pair of the holding portions by the terminal feeding device, one of the holding portions is closed so as to hold and receive the insulation-displacement terminal 20 between the pair of the holding portions.

Furthermore, the terminal insertion mechanism 30 includes the pressure sensor 40 capable of detecting a pressure applied to the insulation-displacement terminal 20 when the insulation-displacement terminal 20 is inserted.

The pressure sensor 40 is composed of piezo elements and the like. When the pressure is applied to the pressure sensor 40, voltage corresponding to the applied pressure is outputted as a pressure detecting signal with the piezoelectric effect of the piezo elements and the like. Then, the pressure detecting signal of the pressure sensor 40 is outputted to a determining part 90 described later, and a quality and defect state determination of the insertion of the insulation-displacement terminal 20 is performed by the determining part 90 on the basis of the pressure detecting signal.

This pressure sensor 40 has a through hole in the center part, and is provided in a sensor holder 42 interposed between the elevating part 34 and the head part 36. That is, the sensor holder 42 includes an upper sensor holder 42a fixed to the elevating part 34, and a lower sensor holder 42b fixed to the head part 36. The pressure sensor 40 is provided along the Z direction between the upper sensor holder 42a and the lower sensor holder 42b.

The upper sensor holder 42a and the lower sensor holder 42b are linked so as to relatively come close and to be spaced apart from each other. More specifically, a through hole opening to be substantially circular (here, the through hole has a diameter slightly larger than an external diameter of a fixing bolt 44) is formed in the upper sensor holder 42a so as to pass the fixing bolt 44 therethrough along the Z direction. In the upper side thereof, a concave part opening to be substantially circular (here, the concave part has a diameter slightly larger than the diameter of a head of the fixing bolt 44, and is slightly deeper than the height of the head) is formed so as to house the head part of the fixing bolt 44. The fixing bolt 44 has the external diameter so as to pass through the through hole formed in the pressure sensor 40. Further, in a lower side of the upper sensor holder 42a, a concave part is formed with the posture such that the pressure sensor 40 is able to measure the pressure applied to the Z direction so as to fit a part of the pressure sensor 40. Still further, in an upper side of the lower sensor holder 42b, a screw hole is formed so as to screw the fixing bolt 44.

Then, the fixing bolt 44 passes through from the upper side of the upper sensor holder 42a, and further passes through the through hole of the pressure sensor 40 fitted into the lower side of the upper sensor holder 42a, allowing a screw part protruding therebelow to be screwed to the screw hole of the lower sensor holder 42b. Thereby, the upper sensor holder 42a and lower sensor holder 42b are coupled. At this time, there is a gap between the upper sensor holder 42a and the lower sensor holder 42b such that they are indirectly coupled through the pressure sensor 40. Thus, pressure in the terminal insertion is suppressed to disperse into a device, so that the pressure applied to the insulation-displacement terminal 20 is detected accurately. Further, by fastening the fixing bolt to couple the upper sensor holder 42a and the lower sensor holder 42b, precompression is applied to the pressure sensor 40, and thus, the pressure is detected accurately from the moment at which the pressure is applied in the terminal insertion.

The aforementioned X-Y stage 52 and the terminal insertion mechanism 30 operate in accordance with a control instruction of an insertion control part 80. The insertion control part 80 is a common computer including a CPU, RAM, ROM, an input/output circuit and the like, which are not shown.

The insertion control part 80 provides the X-Y stage 52 with the control instruction to move the electrical circuit body 10 such that the insertion hole 15 specified as an insertion object in the electrical circuit body 10 into which the insulation-displacement terminal 20 is inserted is disposed at a position almost immediately below a position where the holding part 38 holds the insulation-displacement terminal 20 (a position ahead of a direction to which the holding part 38 comes close), and also provides the terminal insertion mechanism 30 with the control instruction to perform an insertion operation, with a state where the electrical circuit body 10 is supported by the X-Y stage 52. The terminal insertion operation will be described later.

Further, the insertion control part 80 outputs an insertion start signal at a timing of starting the actual insertion operation holding the insulation-displacement terminal 20 again as described later. Then, the outputted insertion start signal is inputted to the determining part 90 so as to be used for a process extracting pressure data of the actual insertion operation of the terminal insertion defect determination. Here, the insertion control part 80 has only to output the insertion start signal at the timing of starting the actual insertion operation. For instance, it may output the insertion start signal after a predetermined time has elapsed, counting time from the insertion start. Alternatively, for instance, by obtaining a rotation angle of the motor used as the driving part in the terminal insertion mechanism 30, it may output the insertion start signal at the time of obtaining a predetermined rotation angle.

Still further, the insertion control part 80 receives a continuing and stopping signal outputted from the determining part 90. When the stopping signal is received, the control instruction for stopping the insertion operation is outputted to the terminal insertion mechanism 30 and the X-Y stage 52 so as to stop the insertion operation.

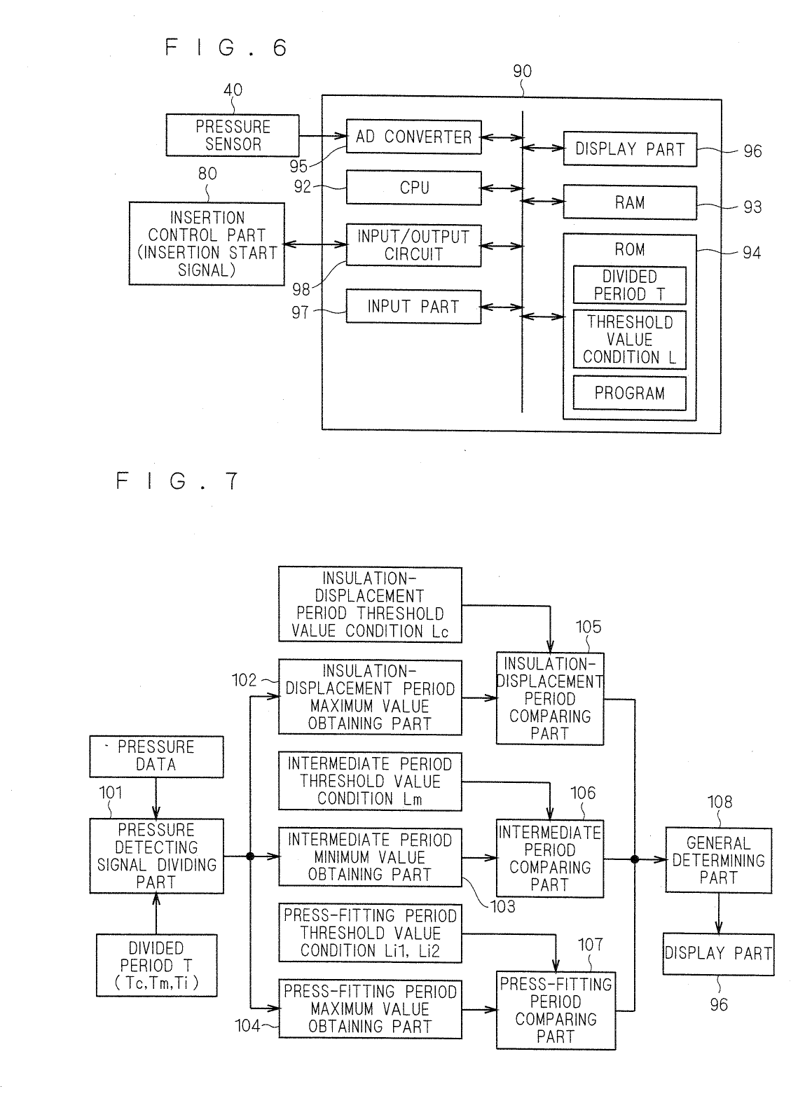

FIG. 6 is a hardware block diagram of the determining part 90. The determining part 90 is configured to divide time series data of the pressure on the basis of the pressure detecting signal of the pressure sensor 40 into an insulation-displacement period Tc, an intermediate period Tm, and a press-fitting period Ti, and judges whether preset conditions are satisfied or not in each period so as to perform the terminal insertion defect determination. More specifically, the determining part 90 is configured such that a CPU 92, RAM 93, ROM 94, an AD converter 95, a display part 96, an input part 97, and an input/output circuit 98 are bus-connected, and the CPU 92 executes a program stored in the ROM 94 so as to perform a process of determining a quality and defect state of the terminal insertion.

The ROM 94 is a nonvolatile semiconductor memory capable of rewriting a flash memory and the like, and stores data such as a divided period T, threshold value condition L, a program and the like. Data of those divided period T and threshold value condition L are appropriately read by the CPU 92 and provided for the determination. Here, the divided period T includes the insulation-displacement period T, intermediate period Tm, press-fitting period Ti, and the threshold value condition L includes an insulation-displacement period lower threshold value Lc as an insulation-displacement period threshold value condition, an intermediate period upper threshold value Lm as an intermediate period threshold value condition, and a press-fitting period lower threshold value Li1 and press-fitting period upper threshold value Li2 as a press-fitting period threshold value condition. These divided period T and threshold value condition L will be described later.

The AD converter 95 is a circuit for converting an analog signal to a digital signal. The pressure detecting signal (a voltage value, here) outputted from the pressure sensor 40 is converted to a digital signal with a predetermined sampling period, and is provided for the determining process inside the determining part 90 as the pressure data in digital form. The time series data of the pressure converted here may be stored in the RAM 93, or may be stored temporarily in the ROM 94 so as to be provided for the determining process inside the determining part 90.

The display part 96 is composed of a common liquid crystal display and the like, and is set to display a pressure waveform with an axis of abscissas as a time and an axis of ordinate as a pressure level on the basis of the pressure data (see FIG. 8). That is, when the insulation-displacement terminal insertion device 60 performs the terminal insertion, the pressure detecting signal from the pressure sensor 40 is analog-to-digital converted in the AD converter, and the display part 96 displays the pressure waveform with an axis of abscissas as a time and an axis of ordinate as a pressure level on the basis of this pressure data. Here, the display part 96 may be set to display the divided period T and threshold value condition L stored in the ROM 94 and described later on the pressure waveform. Alternatively, it may be set to display the quality and defect state of the terminal insertion described later.

In FIG. 6, while the determining part 90 incorporates the AD converter 95 and the display part 96, the AD converter 95 and the display part 96 may be integrally formed as a different device from the determining part 90.

The input part 97 is composed of a common input device such as a key board, a mouse, a touch panel and the like, and is configured to be able to input data such as the divided period T, threshold value condition L, program and the like by an operator. Then, data such as the divided period T, threshold value condition L, program and the like are stored in the ROM 94, and read by the CPU 92 as needed so as to be provided for various processes.

The input/output circuit 98 is an interface circuit performing signal transfer between the insertion control part 80 and the determining part 90, and the insertion start signal outputted from the insertion control part 80 is inputted at the timing of starting the actual insertion operation by the terminal insertion mechanism 30. Further, it is configured to be able to output the continuing and stopping signal from the result of the insertion defect determination to the insertion control part 80 in termination of defect determination of the terminal insertion. Here, when the terminal insertion is determined to be preferable, the input/output circuit 98 outputs the continuing signal, and when it is determined to be a failure, it outputs the stopping signal.

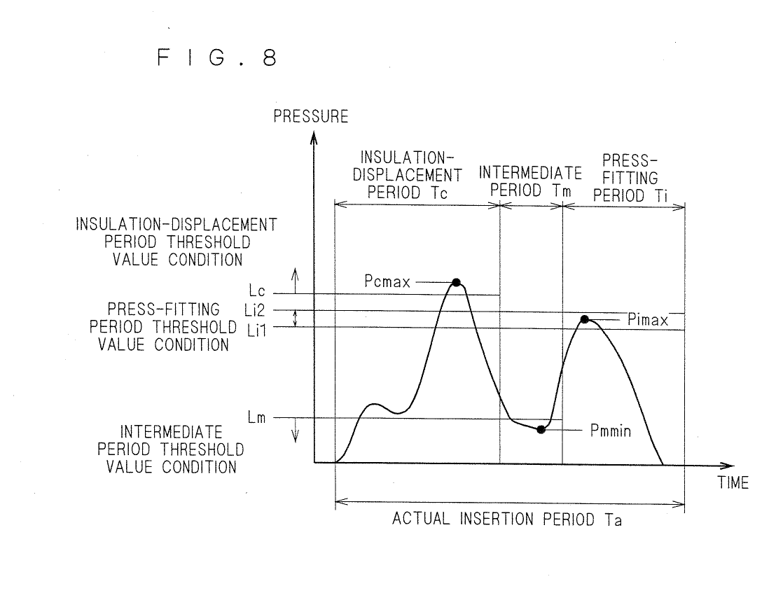

Further, FIG. 7 is a functional block diagram of the determining part 90. The determining part 90 includes a pressure detecting signal dividing part 101, an insulation-displacement period maximum value obtaining part 102, an intermediate period minimum value obtaining part 103, a press-fitting period maximum value obtaining part 104, an insulation-displacement period comparing part 105, an intermediate period comparing part 106, a press-fitting period comparing part 107, a general determining part 108, and a display part 96.

The pressure detecting signal dividing part 101 divides the pressure data in the actual insertion operation obtained by analog-to-digital converting the pressure detecting signal of the pressure sensor 40, into the insulation-displacement period Tc, intermediate period Tm, and press-fitting period Ti on the basis of the divided period T.

The insulation-displacement period maximum value obtaining part 102 obtains a maximum value Pcmax of the pressure data of the insulation-displacement period Tc out of the pressure data divided in the pressure detecting signal dividing part 101. Then, the insulation-displacement period comparing part 105 compares the maximum value Pcmax of the obtained insulation-displacement period Tc to the preset insulation-displacement period lower threshold value Lc, and judges not satisfying the insulation-displacement period threshold value condition when the maximum value Pcmax of the insulation-displacement period Tc is judged to be smaller than the insulation-displacement period lower threshold value Lc.

The intermediate period minimum value obtaining part 103 obtains a minimum value Pmmin of the pressure data of the intermediate period Tm out of the pressure data divided in the pressure detecting signal dividing part 101. Then, the intermediate comparing part 106 compares the minimum value Pmmin of the obtained intermediate period Tm to the preset intermediate period upper threshold value Lm, and judges not satisfying the intermediate period threshold value condition when the minimum value Pmmin of the intermediate period Tm is judged to be larger than the intermediate period upper threshold value Lm.

The press-fitting period maximum value obtaining part 104 obtains a maximum value Pimax of the pressure data of the press-fitting period Ti out of the pressure data divided in the pressure detecting signal dividing part 101. Then, the press-fitting period comparing part 107 compares the maximum value Pimax of the obtained press-fitting period Ti to the preset press-fitting period lower threshold value Li1 and press-fitting period upper threshold value Li2, and judges not satisfying the press-fitting period threshold value condition when the maximum value Pimax of the press-fitting period Ti is smaller than the press-fitting period lower threshold value Li1, or larger than the press-fitting period upper threshold value Li2.

The general determining part 108 determines the terminal insertion to be preferable when all of the judging results obtained from the insulation-displacement period comparing part 105, intermediate period comparing part 106, and press-fitting period comparing part 107 satisfy the conditions, and determines the terminal insertion to be a defect when even one of the judging results does not satisfy the conditions. Here, the general determining part 108 determines that wire or terminal is absent when judging not satisfying the condition in the insulation-displacement period comparing part 105 (the maximum value Pcmax is smaller than the insulation-displacement period lower threshold value Lc, here), and determines that a terminal is displaced when judged not satisfying the condition in the intermediate period comparing part 106 (the minimum value Pmmin is larger than the intermediate period upper threshold value Lm). Further, the general determining part 108 determines to be a shortage of press-fitting when the maximum value Pimax is smaller than the press-fitting period lower threshold value Lit in the judging result of the press-fitting period comparing part 107, and determines to be an excess of press-fitting when the maximum value Pimax is judged to be larger than the press-fitting period upper threshold value Li2.

Then, on the basis of the determining results, the quality of the terminal insertion is outputted to the display part 96, and also the defect state is outputted to the display part 96 with items such as absence of wire or terminal, terminal position displacement, press-fitting shortage, and press-fitting excess, allowing the operator to confirm the state of the terminal insertion. The display of the terminal insertion state in the display part 96 may be represented with various identifiable display modes, for example, such as letters, or symbols and the like.

All these functions are implemented in the CPU 92 of the determining part 90. Of course, a part of the aforementioned functions, or the whole thereof may be implemented as a hardware by a dedicated logical circuit and the like.

<2.2 Terminal Insertion Operation of Insulation-Displacement Terminal Insertion Device>

Next, terminal insertion operation of the insulation-displacement terminal insertion device 60 will be described.

First, in an initial state, the terminal insertion mechanism 30 is disposed at a top dead point where the elevating part 34 is spaced apart from the electrical circuit body 10 (X-Y stage 52) (here, a position where the holding part 38 is disposed when the insulation-displacement terminal 20 is received). Then, the holding part 38 is disposed at a position where the insulation-displacement terminal 20 is received by the aforementioned terminal feeding device (here, a position where the elevating part 34 is at the top dead point) in a state where one of the holding portions is opened so as not to hold the insulation-displacement terminal 20. The X-Y stage 52 is disposed so as to set the electrical circuit body 10.

With the above state, the operator sets the electrical circuit body 10 on the X-Y stage 52, and inputs a terminal insertion operation start instruction. Subsequently, the insertion control part 80 provides a control instruction to move the electrical circuit body 10 to the X-Y stage 52. Then, the X-Y stage 52 moves the electrical circuit body 10 such that the insertion hole 15 specified as an insertion object in the electrical circuit body 10 is disposed at a position almost immediately below a position where the holding part 38 holds the insulation-displacement terminal 20 (a position ahead of a direction to which the holding part 38 comes close).

After the X-Y stage 52 starts moving, one of the holding portions of the holding part 38 is closed by the control instruction from the insertion control part 80 so as to hold the insulation-displacement terminal 20 between the pair of the holding portions. At this time, the holding part 38 holds a part from the top end of the connection part 26 of the insulation-displacement terminal 20 to a boundary between the press-fitting part 23 and the insulation-displacement part 24 to be interposed therebetween.

Immediately before the insulation-displacement terminal 20 is held by the holding part 38 and the electrical circuit body 10 is disposed at the specified position, the holding part 38 is lowered by the terminal insertion mechanism 30 driven by the control instruction of the insertion control part 80, and the insulation-displacement terminal 20 held by the holding part 38 starts to come close to the electrical circuit body 10 supported by the X-Y stage 52. Then, after the electrical circuit 10 has been disposed at the specified position, the insulation-displacement terminal 20 is inserted into the insertion hole 15, and the insulation-displacement part 24 of the insulation-displacement terminal 20 protruded from the top end of the holding part 38 is to be inserted halfway into the insertion hole 15. Here, the insulation-displacement terminal 20 is to be a state where the insulation-displacement part 24 is inserted into the insertion hole 15 so as to be stand-alone. Then, this insertion operation is referred to as a provisional insertion operation.

After the provisional insertion operation, one of the holding portions of the holding part 38 is opened to release the insulation-displacement terminal 20.

After releasing the insulation-displacement terminal 20, the elevating part 34 is moved upward by the driving mechanism 32, and the holding part 38 is moved to be spaced apart from the electrical circuit body 10. At this time, the holding part 38 is moved to be spaced apart until the top end of the holding part 38 is disposed above the height of the boundary between the connection part 26 and the press-fitting part 23, which are protruded from the insertion hole 15 of the stand-alone insulation-displacement terminal 20.

After the holding part 38 is moved to be spaced apart, one of the holding portions is closed once more, so that the holding part 38 is to hold the almost entire connection part 26 of the insulation-displacement terminal 20 (a position slightly above the boundary between the connection part 26 and the press-fitting part 23).

After holding the insulation-displacement terminal 20, the elevating part 34 is moved again downward by the driving mechanism 32, and the holding part 38 is moved to come close to the electrical circuit body 10. Subsequently, the insulation-displacement concave part 24a of the insulation-displacement part 24 of the insulation-displacement terminal 20 is cut into the covering part 18a of the wire 18 laid out on the electrical circuit body 10 so as to connect to the wire 18 by insulation-displacement. At this time, the insulation-displacement concave part 24a makes contact with the core wire 18a of the wire 18, being electrically connected. Thereafter, the entire press-fitting part 23 is press-fitted to the press-fitted part 15b of the electrical circuit body 10, and the insulation-displacement terminal 20 is inserted and connected to the insertion hole 15 (see FIG. 2). This insertion operation is referred to as an actual insertion operation.

After the actual insertion operation, one of the holding portions is opened, and the holding part 38 is to release the insulation-displacement terminal 20.

Then, the elevating part 34 is moved upward (here, the top dead point) by the driving mechanism 32, so that the holding part 38 is moved to be spaced apart from the electrical circuit body 10 so as to be disposed at a position where the supplied insulation-displacement terminal 20 is to be received. Further, the X-Y stage 52 starts to move the electrical circuit body 10 to the next specified position. Thereby, next terminal insertion is performed.

<2.3 Terminal Insertion Defect Determination of Insulation-Displacement Terminal Insertion Device>

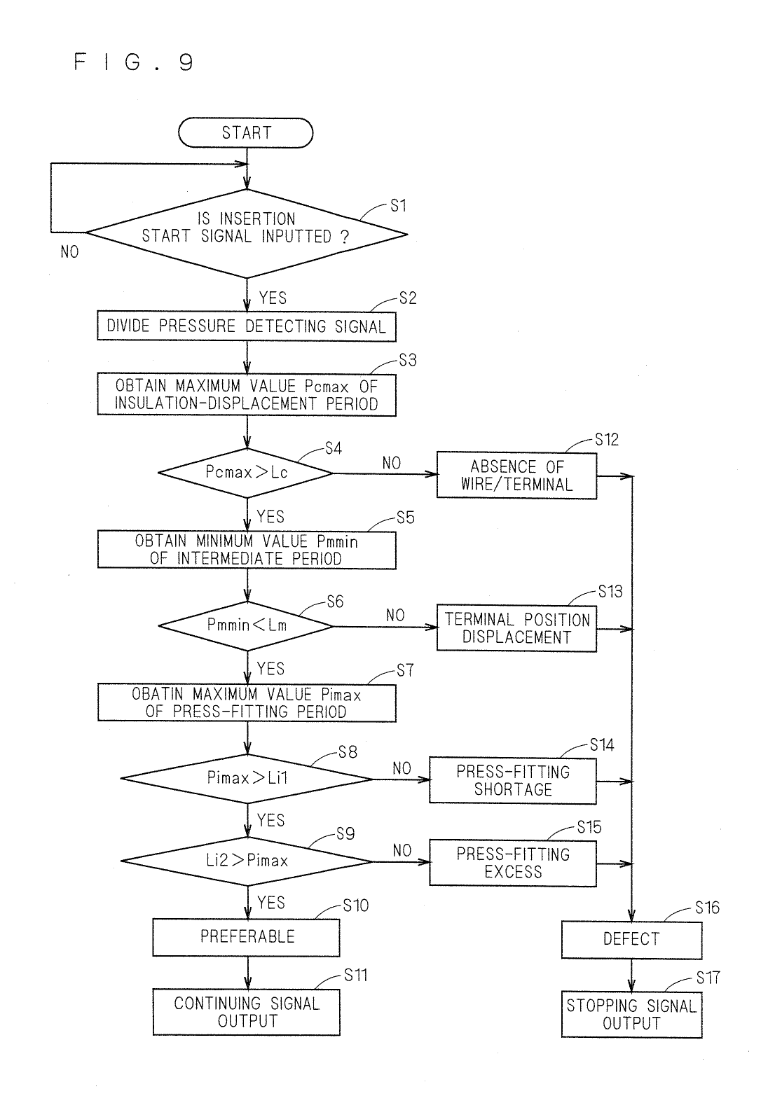

Next, the determining part 90 and the terminal insertion defect determination thereof will be described more in detail. FIG. 8 is an example of a pressure waveform when the terminal is normally inserted, and FIG. 9 is a flow chart of an insertion defect determination of the insulation-displacement terminal 20.

The terminal insertion defect determination is performed on the basis of the threshold value condition L of each period after the divided period T and each threshold value condition L stored in the ROM 94 are appropriately read in accordance with the instruction of a program read by the CPU 92, and the pressure data in the actual insertion operation is divided with the divided period T.

FIG. 8 is an example of the pressure waveform with an axis of ordinate as a pressure and an axis of abscissas as a time in the pressure data when the actual insertion operation is normally performed. In this pressure waveform, a part being convex upward where a pressure is maximum at earlier time along the time axis (a left side of the pressure waveform in FIG. 8) is a pressure waveform when the insulation-displacement terminal 20 is insulation-displaced to the wire 18, a part being convex upward at later time (a right side of the pressure waveform in FIG. 8) is a pressure waveform when the press-fitting part 23 of the insulation-displacement terminal 20 is press-fitted to the press-fitted part 15b, and a part therebetween being convex downward is a pressure waveform from when the insulation-displacement operation is performed until the press-fitting operation starts. Further, a part being slightly convex upward at the beginning is an inertia component when the holding part 38 starts moving to come close from a stopped state at the start of the actual insertion operation.

Here, in order to judge whether each operation satisfies the condition or not, the divided period T dividing the pressure waveform (pressure data in the actual insertion operation) into each operation is set. Then, the divided period T includes the insulation-displacement period Tc, intermediate period Tm, and press-fitting period Ti.

The insulation-displacement period Tc is a period where the insulation-displacement part 24 of the insulation-displacement terminal 20 is insulation-displaced to the wire 18 in FIG. 2. The press-fitting period Ti is a period where the press-fitting part 23 of the insulation-displacement terminal 20 is press-fitted to the press-fitted part 15b of the electrical circuit body 10. The intermediate period Tm is a period between the insulation-displacement period Tc and the press-fitting period Ti. Here, the divided period T is experimentally and presumptively set by the insertion operation of the insulation-displacement terminal 20 by an actual insertion device, or set by a set value and the like. For example, it is set as an elapsed time from a time of inputting an insertion start signal from the insertion control part 80. In this case, a dividing process in the pressure detecting signal dividing part 101 is accomplished by dividing with the elapsed time of the intermediate period T, insulation-displacement period Tc, and press-fitting period Ti with a timing into which the insertion start signal is inputted from the insertion control part 80 as a reference.

Then, when the pressure waveform (pressure data) in the actual insertion operation is divided with the aforementioned divided period T, the threshold value condition L to be a judging reference for judging whether the condition is satisfied in each period is preset. Further, the threshold value condition L includes an insulation-displacement period lower threshold value Lc, an intermediate period upper threshold value Lm, and a press-fitting period lower threshold value Li1 and press-fitting period upper threshold value Li2, which are threshold value conditions in each period.

The insulation-displacement period lower threshold value Lc is a condition to the maximum value Pcmax of the insulation-displacement period Tc, and here, the insulation-displacement period lower threshold value Lc defines the condition of a lower limit of the maximum value Pcmax of the insulation-displacement period Tc. That is, in the insulation-displacement period Tc, since the insulation-displacement part 24 is insulation-displaced to the wire 18, it is assumed that the maximum value Pcmax of the insulation-displacement period Tc is observed to be more than a predetermined pressure necessary for the insulation-displacement if a state of the terminal insertion is normal. Thus, when the maximum value Pcmax is smaller than the insulation-displacement period lower threshold value Lc, it is considered to be an insertion defect. Further, the cause that the maximum value Pcmax of the pressure in the insulation-displacement period Tc is smaller than the insulation-displacement period lower threshold value Lc is considered to be a case where the insulation-displacement terminal 20 or the wire 18 is absent.

The intermediate period upper threshold value Lm is a condition to the minimum value Pmmin of the intermediate period Tm, and here, the intermediate period upper threshold value Lm defines the condition of an upper limit of the minimum value Pmmin of the intermediate period Tm. That is, in the intermediate period Tm, since the insulation-displacement and press-fitting are not performed, it is assumed that the minimum value Pmmin of the pressure in the intermediate period Tm is observed to be not larger than a predetermined pressure if a state of the terminal insertion is normal. Thus, when the minimum value Pmmin is larger than the intermediate period upper threshold value Lm, it is considered to be an insertion defect. Further, the cause that the minimum value Pmmin of the pressure in the intermediate period Tm is larger than the the intermediate period upper threshold value Lm is considered to be a case where the insulation-displacement terminal 20 is not inserted into a normal position (displacement of the insulation-displacement terminal 20), producing unexpected force.

The press-fitting period lower threshold value Li1 and press-fitting period upper threshold value Li2 are the conditions to the maximum value Pimax of the press-fitting period Ti, and here, the press-fitting period lower threshold value Li1 defines the condition of a lower limit and the press-fitting period upper threshold value Li2 defines the condition of an upper limit with respect to the maximum value Pimax. That is, in the press-fitting period Ti, since it is a period where the insulation-displacement terminal 20 is press-fitted to the press-fitted part 15b, it is assumed that the maximum value Pimax of the press-fitting period Ti is observed to be a pressure value within a predetermined range necessary for press-fitting if a state of the terminal insertion is normal. Thus, when the maximum value Pimax is smaller than the press-fitting period lower threshold value Li1, it is considered to be an insertion defect due to a shortage of press-fitting. Also, when the maximum value Pimax is larger than the press-fitting period upper threshold value Li2, it is considered to be an insertion defect due to an excess of press-fitting.

Here, the threshold value condition L set in each period may be a threshold value defining only the lower and upper limits, or may be a threshold value range defining the range from the lower limit to the upper limit. Further, the threshold value condition L is set experimentally or presumptively by the insertion of the insulation-displacement terminal 20.

The insertion defect determining process will be described on the basis of a flow chart shown in FIG. 9.

First, in a step S1, the determining part 90 determines whether the insertion start signal is inputted or not, and when the signal is not inputted, a process in the step S1 is repeated. On the other hand, when the insertion start signal is outputted from the insertion control part 80 at a timing of starting the actual insertion operation, this insertion start signal is inputted into the input/output circuit part 98. Then, the determining part 90 determines that the insertion start signal is inputted, and it proceeds to a step S2.

In the step S2, the determining part 90 reads the divided period T stored in the ROM 94 so as to divide the pressure data into the insulation-displacement period Tc, intermediate period Tm, and press-fitting period Ti, and thereafter, it proceeds to a step S3. At this time, the pressure waveform may be displayed on the display part 96 as shown in FIG. 8 on the basis of the pressure data of the actual insertion period Ta.

In a step S3, the insulation-displacement period maximum value Pcmax is obtained in the pressure data of the divided insulation-displacement period Tc, and it proceeds to a step S4. That is, a maximum value of pressure is searched in the pressure data of the insulation-displacement period Tc, providing this value as the insulation-displacement period maximum value Pcmax.

In the step S4, the insulation-displacement period lower threshold value Lc stored in the ROM 94 is read, and whether the insulation-displacement period maximum value Pcmax is larger than the insulation-displacement period lower threshold value Lc or not (whether satisfying the insulation-displacement period threshold value condition or not) is judged. When judged that the insulation-displacement period maximum value Pcmax is larger than the insulation-displacement period lower threshold value Lc (satisfying the insulation-displacement period threshold value condition), it proceeds to a process in a step S5, and when judged that the insulation-displacement period maximum value Pcmax is smaller than the insulation-displacement period lower threshold value Lc (not satisfying the insulation-displacement period threshold value condition), it proceeds to a step S12. Here, when the insulation-displacement period maximum value Pcmax and the insulation-displacement period lower threshold value Lc are same, it may proceed to either of the steps S5 and S12.

In the step S5, the intermediate period minimum value Tmmin is obtained in the pressure data of the divided intermediate period Tm, and it proceeds to a step S6. That is, a minimum value of pressure is searched in the pressure data of the intermediate period Tm, providing this value as the intermediate period minimum value Pmmin.

In the step S6, the intermediate period upper threshold value Lm stored in the ROM 94 is read, and whether the intermediate period minimum value Pmmin is smaller than the intermediate period upper threshold value Lm or not (whether satisfying the intermediate period threshold value condition or not) is judged. When judged that the intermediate period minimum value Pmmin is smaller than the intermediate period upper threshold value Lm (satisfying the intermediate period threshold value condition), it proceeds to a process in a step S7, and when judged that the intermediate period minimum value Pmmin is larger than the intermediate period upper threshold value Lm (not satisfying the intermediate period threshold value condition), it proceeds to a step S13. Here, when the intermediate period minimum value Pmmin and the intermediate period upper threshold value Lm are same, it may proceed to either of the steps S7 and S13.

In the step S7, the press-fitting period maximum value Pimax is obtained in the pressure data of the divided press-fitting period Ti, and it proceeds to a step S8. That is, a maximum value of pressure is searched in the pressure data of the press-fitting period Ti, providing this value as the press-fitting period maximum value Pimax.

In the step S8, the press-fitting period lower threshold value Li1 stored in the ROM 94 is read, and whether the press-fitting period maximum value Pimax is larger than the press-fitting period lower threshold value Li1 or not (whether satisfying the lower limit of the press-fitting period threshold value condition or not) is judged. When judged that the press-fitting period maximum value Pimax is larger than the press-fitting period lower threshold value Li1 (satisfying the lower limit of the press-fitting period threshold value condition), it proceeds to a process in a step S9, and when judged that the press-fitting period maximum value Pimax is smaller than the press-fitting period lower threshold value Li1 (not satisfying the lower limit of the press-fitting period threshold value condition), it proceeds to a step S14. Here, when the press-fitting period maximum value Pimax and the press-fitting period lower threshold value Li1 are same, it may proceed to either of the steps S9 and S14.

In the step S9, the press-fitting period upper threshold value Li2 stored in the ROM 94 is read, and whether the press-fitting period maximum value Pimax is smaller than the press-fitting period upper threshold value Li2 or not (whether satisfying the upper limit of the press-fitting period threshold value condition or not) is judged. When judged that the press-fitting period maximum value Pimax is smaller than the press-fitting period upper threshold value Li2 (satisfying the upper limit of the press-fitting period threshold value condition), it proceeds to a step S10, and when judged that the press-fitting period maximum value Pimax is larger than the press-fitting period upper threshold value Li2 (not satisfying the upper limit of the press-fitting period threshold value condition), it proceeds to a step S15. Here, when the press-fitting period maximum value Pimax and the press-fitting period upper threshold value Li2 are same, it may proceed to either of the steps S10 and S15.

In the step S10, a state of the terminal insertion is determined to be preferable, outputting to the display part 96, and it proceeds to a step S11. Thereby, a character of “preferable” is displayed on the display part 96. Then, in the step S11, the continuing signal for continuing the terminal insertion operation is outputted. Thereafter, it returns to the step S1, and the defect determination of the terminal insertion is performed again.

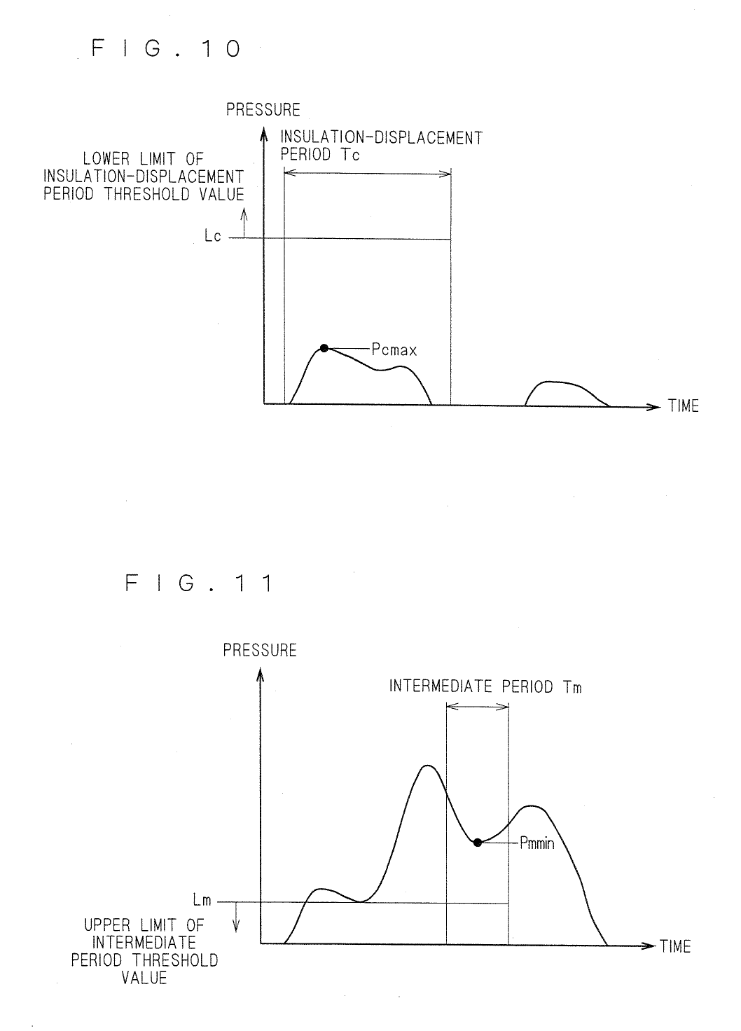

In the step S12, the terminal insertion is determined that wire or terminal is absent, outputting a signal of absence of wire or terminal to the display part 96 and proceeding to a step S16. Thereby, a character of “absence of wire or terminal” is displayed on the display part 96. Here, absence of wire refers to a state where the wire 18 is not disposed in the slit 16 of the protruding part 14 of the electrical circuit body 10, the slit 16 being an object. Also, absence of terminal refers to a state where the terminal insertion operation is performed with a state where the holding part 38 of the insulation-displacement terminal insertion device does not hold the insulation-displacement terminal 20, and the insulation-displacement terminal 20 is not inserted into the insertion hole 15. Then, as shown in FIG. 10, in the defect state that wire or terminal is absent, the pressure is smaller than that in a normal terminal insertion (FIG. 8) over the entire period, showing the pressure waveform in which the insulation-displacement period maximum value Pcmax is smaller than the insulation-displacement period lower threshold value Lc in the insulation-displacement period Tc.

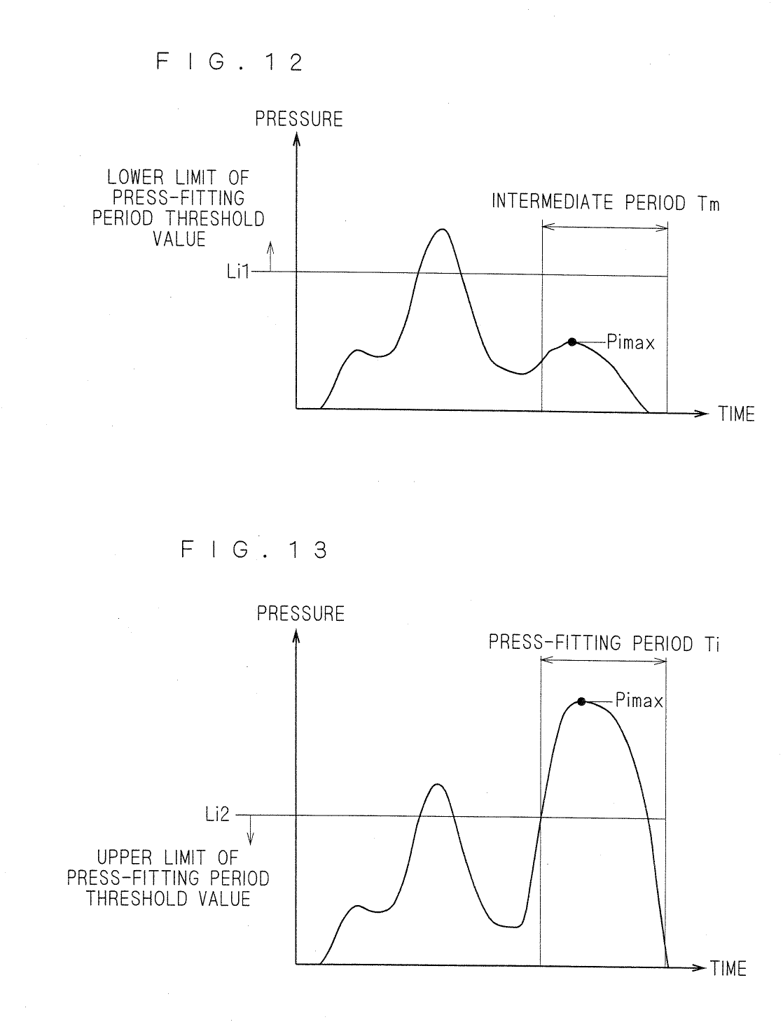

In the step S13, a state of the terminal insertion is determined to be terminal displacement, outputting a signal of terminal displacement to the display part 96 and proceeding to the step S16. Thereby, a character of “terminal displacement” is displayed on the display part 96. Here, the terminal displacement refers to a state where posture of the insulation-displacement terminal 20 inserted into the insertion hole 15 is different from that in the normal insertion, causing alignment defect, because the insulation-displacement terminal 20 is held obliquely, or not held at a predetermined position when the holding part 38 holds the insulation-displacement terminal 20, and the like. Then, as shown in FIG. 11, in the defect state of the terminal displacement, the pressure waveform where the pressure in the intermediate period Tm is larger than that in the normal terminal insertion and the intermediate period minimum value Pmmin is larger than the intermediate period upper threshold value Lm, is shown.

In the step S14, a state of the terminal insertion is determined to be a press-fitting shortage, outputting a signal of a press-fitting shortage to the display part 96, and proceeding to the step S16. Thereby, a character of “press-fitting shortage” is displayed on the display part 96. Here, the press-fitting shortage refers to a state where a holding position of the insulation-displacement terminal 20 by the holding part 38 is closer to a side of the insulation-displacement part 24 than a normal holding position, or where the press-fitting part 23 is not completely press-fitted to the press-fitted part 15b when the press-fitting part 23 of the insulation-displacement terminal 20 is press-fitted because a part of holding the insulation-displacement terminal 20 of the holding part 38 slips in the terminal insertion, and the like. Then, as shown in FIG. 12, in the defect state of a press-fitting shortage, the pressure waveform where the pressure of the press-fitting period Ti is smaller than that in the normal terminal insertion, and the press-fitting period maximum value Pimax is smaller than the press-fitting period lower threshold value Li1, is shown.

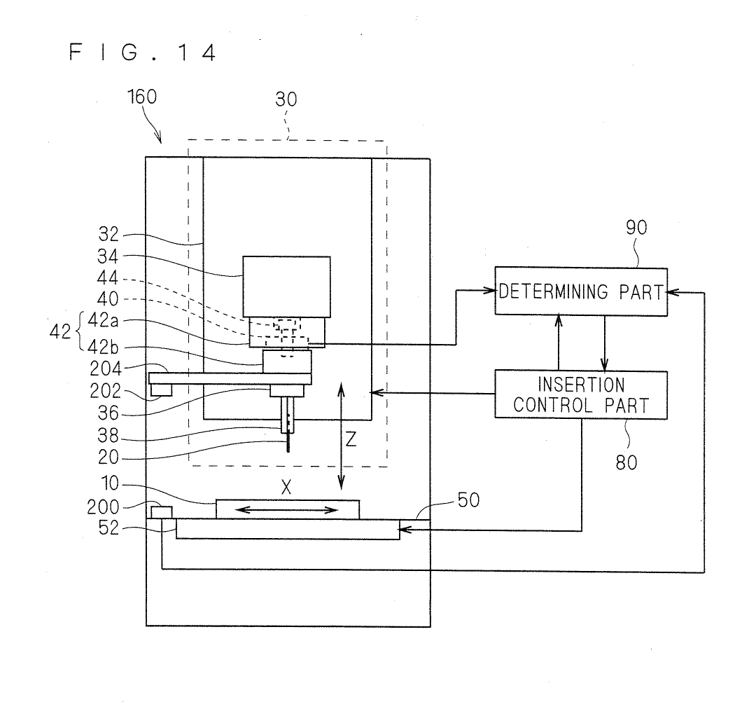

In the step S15, a state of the terminal insertion is determined to be a press-fitting excess, outputting a signal of a press-fitting excess to the display part 96 and proceeding to the step S16. Thereby, a character of “press-fitting excess” is displayed on the display part 96. Here, the press-fitting excess refers to a state where the insertion operation is further continued even after the press-fitting part 23 of the insulation-displacement terminal 20 is completely press-fitted to the press-fitted part 15b when the press-fitting part 23 of the insulation-displacement terminal 20 is press-fitted, and the press-fitting part 23 is inserted closer to a side of the back side part 15a than the press-fitted part 15b of the insertion hole 15, causing a risk of damaging an inside of the insertion hole 15. Then, as shown in FIG. 13, in the state of a press-fitting excess, the pressure waveform where the pressure of the press-fitting period Ti is larger than that in the normal terminal insertion, and the press-fitting period maximum value Pimax is larger than the press-fitting period upper threshold value Li2, is shown.

In the step S16, a state of the terminal insertion is determined to be a defect, outputting a signal of a defect to the display part 96, and proceeding to a step S17. Thereby, a character of “defect” is displayed on the display part 96. Then, in the step S17, a stopping signal for stopping the terminal insertion operation is outputted. Thereafter, it returns to the step S1, and the defect determination of the terminal insertion is performed again.

Here, display of the terminal insertion state in the display part 96 is not limited to a character showing the aforementioned insertion states, but may be represented with various identifiable display modes such as symbols, graphics, and the like.

By confirming the defect state displayed on the display part 96 as above, the operator is able to remove the insulation-displacement terminal 20, determine whether the electrical circuit body 10 is used or not, and remove the electrical circuit body 10, and in addition, it is useful for investigating the cause of defects of the insulation-displacement terminal device 60 and the like.

Here, in FIG. 9, the judging process in each period (processes in S3 and S4, S5 and S6, S7 and S8, S9) is expressed as a serial processing. However, this may be any process configurations of a parallel processing, serial processing, or a fictitious parallel processing. That is, a process may be performed to judge in each period as in the above, and to determine the terminal insertion defect on the basis of the judging result of each period. Further, an order of the process of the aforementioned terminal insertion defect determination may be changed as long as the similar determination is possible. However, in the case of the defect state that wire or terminal is absent, the pressure is assumed to be smaller than the press-fitting period lower threshold value Li1 in the press-fitting period Ti, as shown in FIG. 10. Therefore, when the process in the step S9 is performed before the process in the step S6, the risk is caused to determine a defect state to be a press-fitting shortage, even though it is a defect state that wire or terminal is absent. Thus, by performing the process in the step S6 before the process in the step S9, a defect state is more certainly specified.

According to the terminal insertion defect determination method described above, a condition suitable for determining a state of the terminal insertion with respect to each of the insulation-displacement period Tc, intermediate period Tm, press-fitting period Ti, with the pressure in the terminal insertion, can be set, allowing to determine the defect state of the terminal insertion on the basis of the judging result of each period.

Meanwhile, in a preferable insertion, the pressure is large in insulation-displacement and press-fitting, and is small in the intermediate therebetween. Thus, by judging whether the insulation-displacement period maximum value Pcmax satisfies an insulation-displacement period threshold value condition or not in the insulation-displacement period Tc, judging whether the intermediate period minimum value Pmmin satisfies an intermediate period threshold value condition or not in the intermediate period Tm, and judging whether the press-fitting period maximum value Pimax satisfies a press-fitting period threshold value condition or not in the press-fitting period Ti, the defect state of the terminal insertion is determined on the basis of the judging result of each period.

Further, the insulation-displacement period maximum value Pcmax is judged whether it is larger than the insulation-displacement period lower threshold value Lc or not (whether satisfying the insulation-displacement period threshold value condition or not) in the insulation-displacement period Tc. The intermediate period minimum value Pmmin is judged whether it is smaller than the intermediate period upper threshold value Lm or not (whether satisfying the intermediate period threshold value condition or not) in the intermediate period Tm. The press-fitting period maximum value Pimax is judged whether it is larger than the press-fitting period lower threshold value Lit or not and whether it is smaller than the press-fitting period upper threshold value Li2 or not (whether satisfying the press-fitting period threshold value condition or not) in the press-fitting period Ti. Thereby, the defect state of the terminal insertion is more appropriately determined on the basis of the judging result of each period.

Further, when the insulation-displacement period maximum value Pcmax is judged to be smaller than the insulation-displacement period lower threshold value Lc (not satisfying the insulation-displacement period threshold value condition), it is determined to be absence of wire or terminal. When the intermediate period minimum value Pmmin is judged to be larger than the intermediate period upper threshold value Lm (not satisfying the intermediate period threshold value condition), it is determined to be terminal displacement. When the press-fitting period maximum value Pimax is judged to be smaller than the press-fitting period lower threshold value Li1 (not satisfying the press-fitting period threshold value condition), it is determined to be a shortage of press-fitting, and when the press-fitting period maximum value Pimax is judged to be larger than the press-fitting period upper threshold value Li2 (not satisfying the press-fitting period threshold value condition), it is determined to be an excess of press-fitting. Therefore, the defect state of the terminal insertion is allowed to be specified.

Furthermore, the terminal defect determination is performed by whether or not the maximum value or minimum value satisfies the threshold value condition, not for the entire pressure waveform, but for each period divided into each operation. Therefore, for example, even when the electrical circuit body 10 is formed of a material such as plastic which is relatively easy to deform and has wide variation of the pressure waveform in the insulation-displacement terminal insertion, erroneous determination caused by variation of the pressure waveform is suppressed.

According to the insulation-displacement terminal insertion device 60 configured as the above, it includes the terminal insertion mechanism 30 for inserting the insulation-displacement terminal 20 into the insertion hole 15 by including the holding part 38 capable of holding and releasing the insulation-displacement terminal 20 and moving the holding part 38 so as to come close to the electrical circuit body 10 with a state of holding the insulation-displacement terminal 20, the pressure sensor 40 for outputting the pressure detecting signal in accordance with the pressure applied to the insulation-displacement terminal 20 in inserting the insulation-displacement terminal 20, and the determining part 90 for determining the quality of the insertion of the insulation-displacement terminal 20 by judging whether or not the pressure applied to the insulation-displacement terminal 20 satisfies the preset condition in each period of the insulation-displacement period Tc where the insulation-displacement part 24 is insulation-displaced to the wire 18, the press-fitting period Ti where the press-fitting part 23 is press-fitted to the press-fitted part 15b, and the intermediate period Tm therebetween. Thus, the pressure data from the start of the actual insertion operation is divided into the insulation-displacement period Tc, the intermediate period Tm, and the press-fitting period Ti provided for each insertion action of insulation-displacement action, press-fitting action, and action therebetween in the actual insertion operation, and the threshold value condition L is set in each period of the insulation-displacement period Tc, the intermediate period Tm, and the press-fitting period Ti. Thereby, it is judged whether the threshold value condition L is satisfied or not in each period, and the terminal defect determination of the insulation-displacement terminal 20 is more accurately performed by judging whether all the conditions are satisfied or not.

In the present preferred embodiment, while it is judged whether or not the maximum value Pcmax of the insulation-displacement period Tc, the minimum value Pmmin of the intermediate period Tm, and the maximum value Pimax of the press-fitting period Ti satisfies the threshold value condition L set in each period, the terminal insertion defect determining method is not limited to the present embodiment. For example, conformity may be observed between a reference waveform and a measurement waveform of the pressure in each period.

Further, while the terminal insertion defect determining method determining the defect state of the terminal insertion with items such as absence of wire or terminal, terminal displacement, a shortage of press-fitting, and an excess of press-fitting on the basis of the judging results has been shown, the method is not limited to this determining method. The terminal insertion defect determining method has only to judge whether the condition is satisfied or not in the insulation-displacement period Tc, the intermediate period Tm, and the press-fitting period Ti, and determine the defect state of the terminal insertion on the basis of the judging results.

### Second Preferred Embodiment

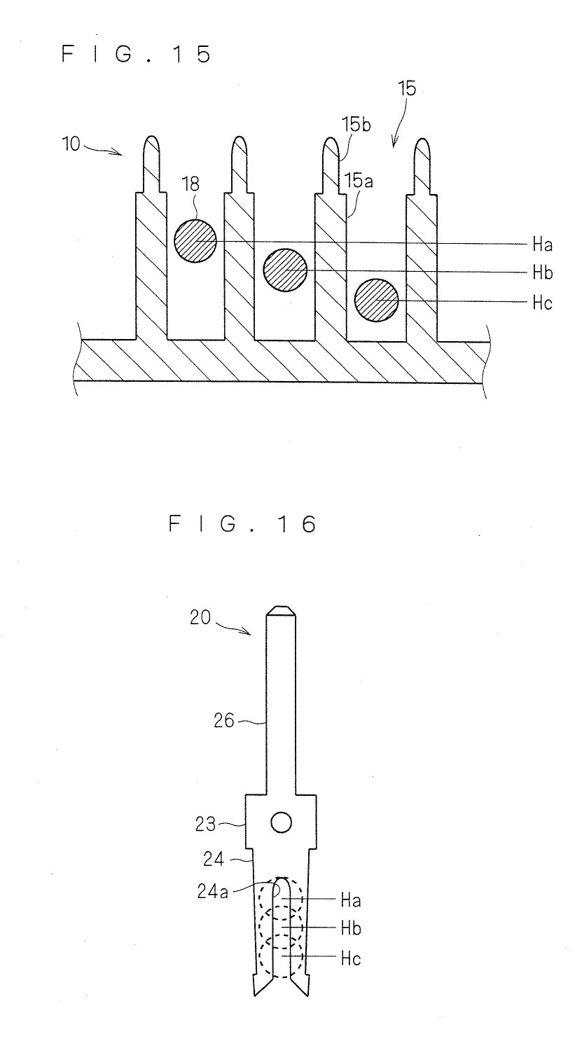

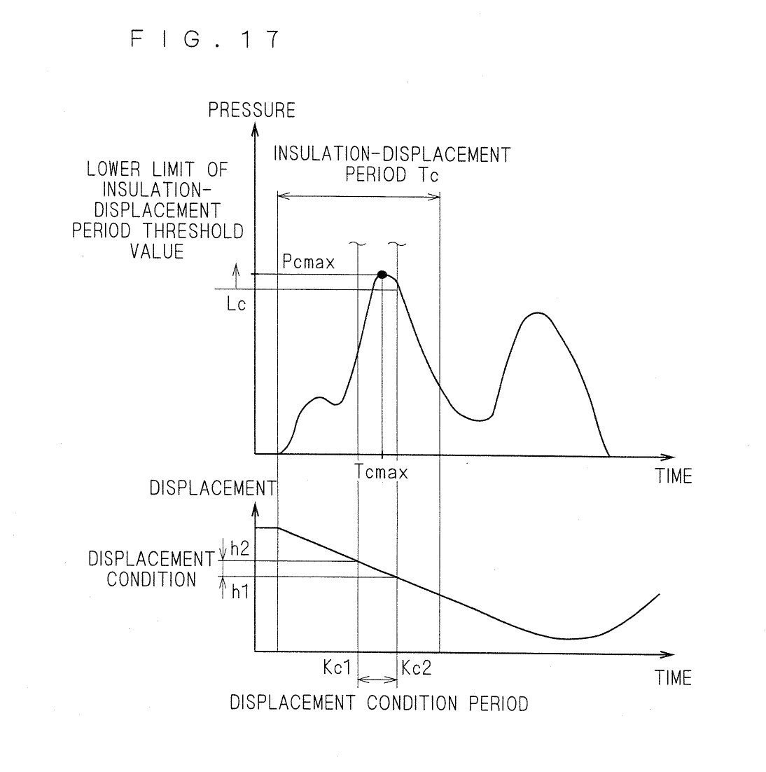

Next, the insulation-displacement terminal insertion device according to the second preferred embodiment will be described. FIG. 14 is a schematic front view of an insulation-displacement terminal insertion device 160 according to the second preferred embodiment. FIG. 15 is a view of showing that the height of the wire 18 laid out on the electrical circuit body 10 is different. FIG. 16 is a view of showing the height of the insulation-displacement when the insulation-displacement terminal is inserted in the case that the height of the wire 18 is different. With respect to the description in the present embodiment, differences with the first preferred embodiment will be mostly explained, and components identical to those of the first preferred embodiment are denoted by the same reference numbers, the description of which is thus omitted.

As shown in FIG. 15, there are cases where the wire 18 laid out on the electrical circuit body 10 is disposed at different heights depending on the insertion hole 15 (Ha, Hb, Hc). In accordance therewith, as shown in FIG. 16, a position where the insulation-displacement part 24 of the insulation-displacement terminal 20 is insulation-displaced to the wire 18 is different. That is, when the wire 18 is at an upper position (referring to Ha) which is near an opening at a side of insertion of the insertion hole 15, the insulation-displacement part 24 is insulation-displaced to the wire 18 at relatively earlier point in time after starting the insertion. In contrast, when the wire 18 is at a lower position (referring to Hc) which is near a bottom side of the insertion hole 15, the insulation-displacement part 24 is insulation-displaced to the wire 18 at relatively later point in time after starting the insertion. At this time, a position (time) which the maximum value Pcmax of the insulation-displacement period Tc appears is different because of the height differences of the wire. Thus, the terminal insertion device 160 according to the second preferred embodiment is aimed at performing the defect determination of the terminal insertion more accurately by providing different determining conditions for the wire 18 laid out at different heights, respectively. Therefore, the terminal insertion device 160 according to the second preferred embodiment detects displacement of the holding part 38 in the terminal insertion by using a displacement sensor 200, and judges whether or not the maximum value Pcmax of the insulation-displacement period Tc exists within a period condition (displacement condition period) Kc1-Kc2 when the displacement is within the preset displacement condition.

In the second preferred embodiment, an electrical circuit body supporting part 50 includes the displacement sensor 200. The displacement sensor 200 is composed of a non-contact type displacement sensor including well-known sensors such as an eddy-current type displacement sensor, a laser displacement sensor, an ultrasonic displacement sensor and the like, and is configured to detect displacement in a direction to which the holding part 38 comes close to and is spaced apart from the electrical circuit body 10 (Z direction) so as to output a displacement detecting signal on the basis of the displacement. Here, the displacement sensor 200 is disposed at an immovable portion outside the X-Y stage 52 of the electrical circuit body supporting part 50. Further, a detected part supporting part 204 is provided on an upper side of a head part 36 of the terminal insertion mechanism 30. The detected part supporting part 204 supports a detected part 202 so as to dispose at a position immediately above the displacement sensor 200 disposed on the electrical circuit body supporting part 50. Thereby, the insulation-displacement terminal insertion device 160 is configured such that when the head part 36 including the holding part 38 comes close to and be spaced apart from the electrical circuit body 10 in the terminal insertion, the detected part 202 comes close to and be spaced apart from the displacement sensor 200, so as to detect displacement in a direction to which the holding part 30 comes close and be spaced apart (Z direction).

The displacement detecting signal outputted from the displacement sensor 200 is inputted to the determining part 90, and converted to a digital signal by the AD converter 95 of the determining part 90 with a predetermined sampling period, and then provided for the determining process of the determining part 90 as displacement data in digital form. Time series data of displacement which is analog-to-digital converted here may be stored in the RAM 93, or stored in the ROM 94 once and provided for the determining process inside the determining part 90.

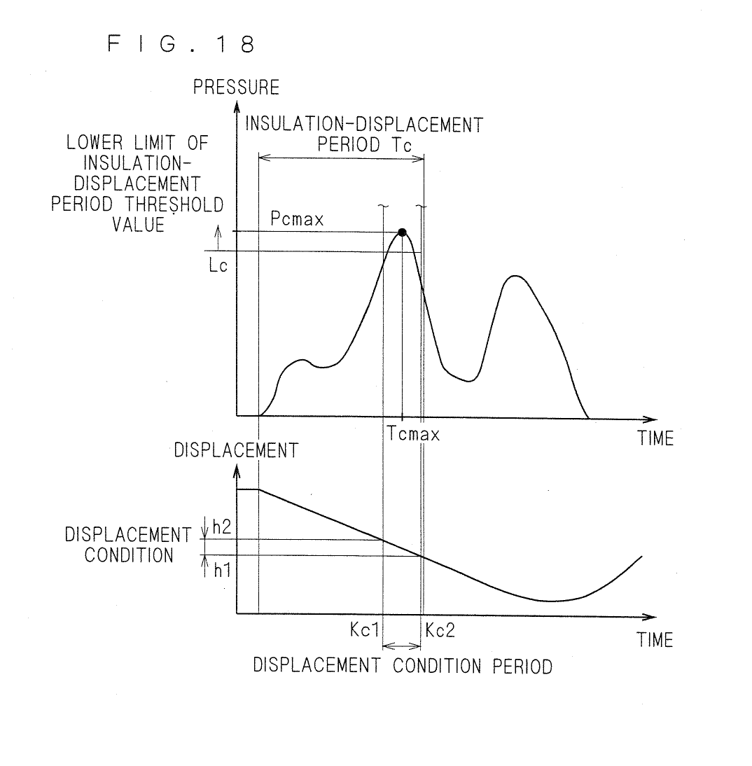

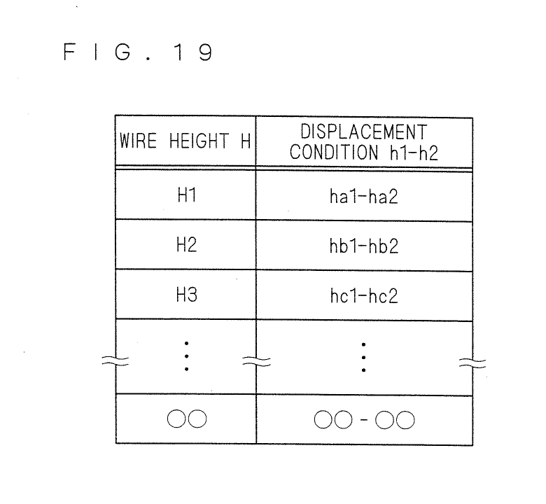

FIG. 17 is a pressure waveform and displacement waveform when the insulation-displacement terminal 20 is normally and actually inserted into the insertion hole 15 with the wire 18 laid out at the height of Ha in FIG. 15. FIG. 18 is the pressure waveform and displacement waveform when the insulation-displacement terminal 20 is normally and actually inserted into the insertion hole 15 with the wire 18 laid out at the height of Hc in FIG. 15.

When the wire 18 is laid out at the height of Ha (a position higher than Hc), the insulation-displacement part 24 is insulation-displaced to the wire 18 at relatively earlier point in time after the insertion starts, so that a time at which the maximum value Pcmax of the insulation-displacement period Tc (insulation-displacement period maximum value time Tcmax) appears at relatively earlier point in time, as shown in FIG. 17. In contrast, when the wire 18 is laid out at the height of Hc (a position lower than Ha), the insulation-displacement part 24 is insulation-displaced to the wire 18 at relatively later point in time after the insertion starts, so that the insulation-displacement period maximum value time Tcmax appears at relatively later point in time. That is, when the wire 18 is disposed at the specified position, the insulation-displacement period maximum value time Tcmax is assumed to appear within a period where the holding part 38 of the insulation-displacement terminal insertion device 60 is positioned in a certain displacement range on the basis of the wire position. Thus, when the insulation-displacement period maximum value time Tcmax does not appear within the period on the basis of the preset displacement range, it is considered to be an abnormal wire position.

Here, the height of the wire 18 laid out on the electrical circuit body 10 with different heights is divided into several levels as a wire height H, and displacement condition h1-h2 with which the maximum value Pcmax of the insulation-displacement period Tc should appear to the wire height H in each insertion hole 15 is preset.

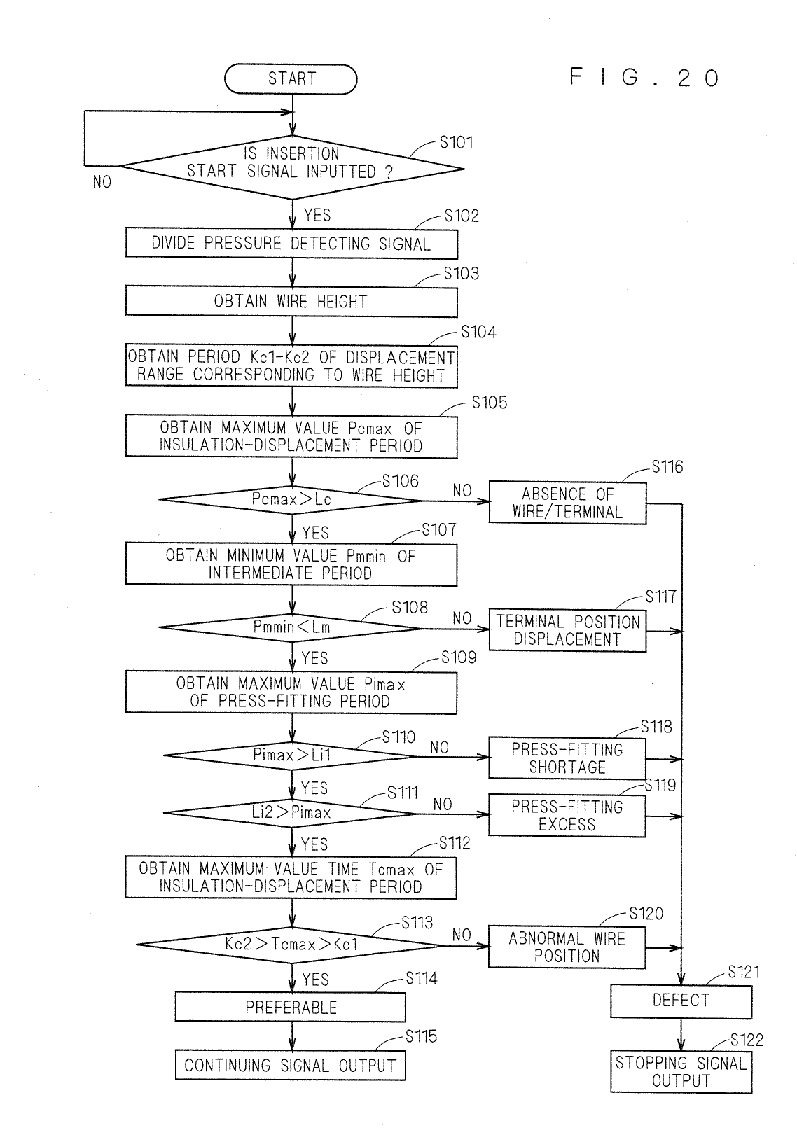

Here, a correspondence table of the displacement condition h1-h2 to the wire height H as shown in FIG. 19 can be displayed on the display part 96, and the wire height H and the displacement condition h1-h2 can be inputted to the correspondence table by the input part 97. Then, the wire height H and the displacement condition h1-h2 corresponding thereto, inputted by the input part 97, are stored in the ROM 94, and appropriately read into the CPU 92.

Further, information on the height of the wire 18 laid out on the electrical circuit body 10 is stored as the wire height H divided into several levels in the ROM 94 for each insertion hole 15 in the order to be inserted, and appropriately read into the CPU 92. This data of the wire height H for each insertion hole 15 is preferably inputted by the input part 97. The wire height H is determined in accordance with interconnecting patterns of the wire 18 laid out on the electrical circuit body 10, a shape of the slit 16 and the like, so that it may be determined on the basis of a specification of such an electrical circuit body 10 itself and the like.

Here, the correspondence between the wire height H and displacement condition h1-h2 is determined in accordance with a length of the insulation-displacement part 24 of the insulation-displacement terminal 20, a depth of the insulation-displacement concave part 24a, a wire height and the like, and can be experimentally and presumptively set.

Next, the terminal insertion defect determining method of the insulation-displacement terminal insertion device 160 according to the second preferred embodiment will be described. FIG. 20 is a flow chart of showing the defect determining process of the terminal insertion of the insulation-displacement terminal insertion device 160 according to the second preferred embodiment.

First, in a step S101, the determining part 90 determines whether the insertion start signal is inputted or not, and when it is not inputted, a process of the step S101 is repeated. On the other hand, when the insertion start signal is outputted from the insertion control part 80 at a timing of starting the actual insertion operation, the insertion start signal is inputted to the input/output circuit 98. Then, the determining part 90 determines that the insertion start signal is inputted, and then it proceeds to a step S102.

In the step S102, the determining part 90 reads the divided period T stored in the ROM 94 so as to divide the pressure data into the insulation-displacement period Tc, the intermediate period Tm, and the press-fitting period Ti, and thereafter, it proceeds to a step S103. At this time, the pressure waveform as shown in FIGS. 17 and 18 may be preferably displayed on he display part 96 on the basis of the pressure data of the actual insertion period Ta.

In the step S103, the wire height H in the specified insertion hole 15 is read out of data of the wire height H stored in the ROM 94, and then it proceeds to a step S104.

In the step S104, among the correspondence relationships between the wire height H and the displacement condition h1-h2 stored in the ROM 94, the displacement condition h1-h2 corresponding to the wire height H in the specified insertion hole 15 having been read in the step S103 is read, and then it proceeds to a step S105. Subsequently, a period where a displacement is within the displacement condition h1-h2 is searched in the insulation-displacement period Tc on the basis of the displacement waveform (displacement data) outputted from the displacement sensor 200, providing this period as a displacement condition period Kc1-Kc2. At this time, the displacement condition h1-h2 may include h1 and h2, or may not include h1 and h2.

In the step S105, the insulation-displacement period maximum value Pcmax is obtained in the pressure data of the divided insulation-displacement period Tc, and then it proceeds to a step S106. That is, a maximum value of pressure is searched in the pressure data of the insulation-displacement period Tc, providing this value as the insulation-displacement period maximum value Pcmax.

In the subsequent step S106, the insulation-displacement period lower threshold value Lc stored in the ROM 94 is read, and it is judged whether the insulation-displacement period maximum value Pcmax is larger than the insulation-displacement period lower threshold value Lc (whether satisfying the insulation-displacement period threshold value condition or not). When the insulation-displacement period maximum value Pcmax is judged to be larger than the insulation-displacement period lower threshold value (satisfying the insulation-displacement period threshold value condition), it proceeds to a step S107. When the insulation-displacement period maximum value Pcmax is judged to be smaller than the insulation-displacement period lower threshold value Lc (not satisfying the insulation-displacement period threshold value condition), it proceeds to a step S116. Here, when the insulation-displacement period maximum value Pcmax and the insulation-displacement period lower threshold value Lc are same, it may proceed to either of the steps S107 and S116.

In the step S107, the intermediate period minimum value Pmmin is obtained in the pressure data of the divided intermediate period Tm, and it proceeds to a step S108. That is, a minimum value of pressure is searched in the pressure data of the intermediate period Tm, providing this value as the intermediate period minimum value Pmmin.

In the step S108, the intermediate period upper threshold value Lm stored in the ROM 94 is read, and it is judged whether the intermediate period minimum value Pmmin is smaller than the intermediate period upper threshold value Lm or not (whether satisfying the intermediate period threshold value condition or not). When the intermediate period minimum value Pmmin is judged to be smaller than the intermediate period upper threshold value Lm (satisfying the intermediate period threshold value condition), it proceeds to a step S109. When the intermediate period minimum value Pmmin is judged to be larger than the intermediate period upper threshold value Lm (not satisfying the intermediate period threshold value condition), it proceeds to a step S117. Here, when the intermediate period minimum value Pmmin and the intermediate period upper threshold value Lm are same, it may proceed to either of the steps S109 and S117.

In the step S109, the press-fitting period maximum value Pimax is obtained in the pressure data of the divided press-fitting period Ti, and it proceeds to a step S110. That is, a maximum value of pressure is searched in the pressure data of the press-fitting period Ti, providing this value as the press-fitting period maximum value Pimax.

In the step S110, The press-fitting period lower threshold value Li1 stored in the ROM 94 is read, and it is judged whether the press-fitting period maximum value Pimax is larger than the press-fitting period lower threshold value Li1 or not (whether satisfying the press-fitting period threshold value condition or not). When the press-fitting period maximum value Pimax is judged to be larger than the press-fitting period lower threshold value Li1 (satisfying the lower limit of the press-fitting period threshold value condition), it proceeds to a step S111. When the press-fitting period maximum value Pimax is judged to be smaller than the press-fitting period lower threshold value Li1 (not satisfying the lower limit of the press-fitting period threshold value condition), it proceeds to a step S118. Here, when the press-fitting period maximum value Pimax and the press-fitting period lower threshold value Li1 are same, it may proceed to either of the steps S111 and S118.

In the step S111, the press-fitting period upper threshold value Li2 stored in the ROM 94 is read, and it is judged whether the press-fitting period maximum value Pimax is smaller than the press-fitting period upper threshold value Li2 (whether satisfying the upper limit of the press-fitting period threshold value condition or not). When the press-fitting period maximum value Pimax is judged to be smaller than the press-fitting period upper threshold value Li2 (satisfying the upper limit of the press-fitting period threshold value condition), it proceeds to a step S112. When the press-fitting period maximum value Pimax is judged to be larger than the press-fitting period upper threshold value Li2 (not satisfying the upper limit of the press-fitting period threshold value condition), it proceeds to a step S119. Here, when the press-fitting period maximum value Pimax and the press-fitting period upper threshold value Li2 are same, it may proceed to either of the steps S112 and S119.

In the step S112, the insulation-displacement period maximum value time Tcmax in which the insulation-displacement period maximum value Pcmax appears is obtained in the insulation-displacement period Tc, and it proceeds to a step S113. That is, a time at which the insulation-displacement period maximum value Pcmax appears is searched in the pressure data of the insulation-displacement period Tc, providing this value as the insulation-displacement period maximum value time Tcmax.

In the step S113, it is judged whether the insulation-displacement period maximum value time Tcmax obtained in the step S112 satisfies the displacement condition period Kc1-Kc2 or not, that is, it is judged whether the insulation-displacement period maximum value time Tcmax is larger than the time Kc1 and smaller than the time Kc2 or not. When the judging result is “YES”, it proceeds to a step S114, and when the judging result is “NO”, it proceeds to a step S120. Here, when the insulation-displacement period maximum value time Tcmax, and the displacement condition period Kc1 or Kc2 are same, it may proceed to either of the steps S114 and S120.

In the step S114, a state of the terminal insertion is determined to be preferable, and a signal that the terminal insertion is preferable is outputted to the display part 96, then proceeding to a step S115. Thereby, a character of “preferable” is displayed on the display part 96. Subsequently, in the step S115, a continuing signal for continuing the terminal insertion operation is outputted. Thereafter, it returns to the step S101, and the defect determination of the terminal insertion is performed once again.

In the step S116, a state of the terminal insertion is determined that wire or terminal is absent, and a signal that wire or terminal is absent is outputted to the display part 96, then proceeding to a step S121. Thereby, a character of “absence of wire or terminal” is displayed on the display part 96.

In the step S117, a state of the terminal insertion is determined to be terminal displacement, and a signal of terminal displacement is outputted to the display part 96, then proceeding to the step S121. Thereby, a character of “terminal displacement” is displayed on the display part 96.

In the step S118, a state of the terminal insertion is determined to be a shortage of press-fitting, and a signal of a shortage of press-fitting is outputted to the display part 96, then proceeding to the step S121. Thereby, a character of “shortage of press-fitting” is displayed on the display part 96.

In the step S119, a state of the terminal insertion is determined to be an excess of press-fitting, and a signal of an excess of press-fitting is outputted to the display part 96, then proceeding to the step S121. Thereby, a character of “excess of press-fitting” is displayed on the display part 96.

In the step S120, a state of the terminal insertion is determined to be an abnormal wire position, and a signal of an abnormal wire position is outputted to the display part 96, then proceeding to the step S121. Thereby, a character of “abnormal wire position” is displayed on the display part 96. Here, the abnormal wire position refers to a state where the wire 18 disposed in the slit 16 of the protruding part 14 of the electrical circuit body 10, which the slit 16 is an object, is not at the specified height. Then, in the defect state of the abnormal wire position, a pressure waveform where the insulation-displacement period maximum value time Tcmax with the insulation-displacement period maximum value Pcmax being seen is outside the displacement condition period Kc1-Kc2 (earlier time or later time than the displacement condition period Kc1-Kc2) in the insulation-displacement period Tc appears.

In the step S121, a state of the terminal insertion is determined to be a defect, and a signal of a defect is outputted to the display part 96, then proceeding to a step S122. Thereby, a character of “defect” is displayed on the display part 96. Then, in the step S122, a stopping signal of stopping the terminal insertion operation is outputted. Thereafter, it returns to the step S101, and the defect determination of the terminal insertion is performed again.

Here, the display of the terminal insertion state in the display part 96 is not limited to the character showing the aforementioned insertion state, but may be represented with various identifiable display modes such as symbols, graphics, and the like.

By confirming the defect state displayed on the display part 96 as the above, the operator is able to remove the insulation-displacement terminal 20, determine whether the electrical circuit body 10 is used or not, and remove the electrical circuit body 10, and in addition, it is useful for investigating the cause of the defect of the insulation-displacement terminal device 160 and the like.

Here, in FIG. 20, the judging processes in each period (processes in the steps S105 and S106, S107 and S108, S109 and S110, S111, S112, and S113) are expressed as a serial processing. However, this may be any process configurations of a parallel processing, serial processing, or a fictitious parallel processing. That is, a process may be performed to judge in each period as in the above, and to determine the terminal insertion defect on the basis of the total judging results of all the periods. Further, an order of the process of the aforementioned terminal insertion defect determination may be changed as long as the similar determination is possible. However, in the case of the defect state of terminal displacement, a timing at which the insulation-displacement period maximum value Pcmax is produced (insulation-displacement period maximum value time Tcmax) as shown in FIG. 11 may be later than the time of normal terminal insertion (FIG. 8). Therefore, when the defect determination of the abnormal wire position is performed before the defect determination of the terminal displacement, the risk is caused to determine a defect to be the abnormal wire position, even though it is a defect of the terminal displacement. Thus, when the order of the processes is changed, by performing the process in the step S108 before the process in the step S113, a defect state is more certainly specified.

According to the terminal insertion defect determining method described above, the effects described as below are obtained in addition to the effects of the first preferred embodiment. The displacement condition h1-h2 is set with respect to the defined wire height H, and the displacement condition period Kc1-Kc2 where the displacement data of the holding part 38 in the terminal insertion is within the displacement condition h1-h2 is obtained. Then, the terminal insertion defect determination is performed by judging whether the insulation-displacement period maximum value time Tcmax in which the insulation-displacement period maximum value Pcmax appears satisfies the displacement condition period Kc1-Kc2 or not. Thereby, even when the height of disposing the wire laid out on the electrical circuit body 10 is defined, the defect of the abnormal wire position is specified in addition to the items of absence of wire or terminal, terminal displacement, a shortage of press-fitting, and an excess of press-fitting, by setting the judging conditions with respect to the defined height of the wire 18.

The insulation-displacement terminal insertion device 160 configured as the above is also configured to be able to obtain the displacement data on the basis of the displacement detecting signal of the displacement sensor 200 disposed on the electrical circuit body supporting part 50. Further, the wire height H of each insertion hole 15 is stored in the determining part 90 of the insulation-displacement terminal insertion device 160, and wire height information of the insertion hole 15 into which the terminal is inserted is obtained. Still Further, when the terminal insertion is preferable, the displacement condition h1-h2 in which the insulation-displacement period maximum value Pcmax appears is preset, and the displacement condition period Kc1-Kc2 where the aforementioned displacement data is within the displacement condition h1-h2 is obtained. Then, the defect determination of the terminal insertion is performed by judging whether the insulation-displacement period maximum value time Tcmax in which the insulation-displacement period maximum value Pcmax appears satisfies the displacement condition period Kc1-Kc2 or not. Thereby, even when the wire 18 laid out on the electrical circuit body 10 is disposed at several different heights in each insertion hole 15, the judging condition is added for each wire height, and it is judged more precisely with suitable condition for each so as to determine the defect state of the terminal insertion more accurately.

While the aforementioned preferred embodiments have been described with the examples of applying the terminal insertion defect determining method to the insulation-displacement terminal insertion devices 60 and 160, the terminal insertion defect determining method is applicable to a terminal insertion device other than the insulation-displacement terminal insertion devices 60 and 160, for example, applicable to a device for inserting an insulation-displacement terminal with one insertion operation without a provisional insertion operation.

While the terminal insertion defect determining method has been shown and described in detail as above, the foregoing description is in all aspects illustrative and the invention is not restrictive thereto. It is therefore understood that numerous modifications and variations can be devised without departing from the scope of the invention.

1. A terminal insertion defect determining method for determining an insertion defect of an insulation-displacement terminal including an insulation-displacement part to be insulation-displaced to a wire and a press-fitting part to be press-fitted to a press-fitted part after said insulation-displacement part is insulation-displaced to said wire, when said insulation-displacement terminal is inserted into an insertion hole with said press-fitted part formed therein, the insertion hole being provided on an electrical circuit body with said wire laid out so as to traverse said insertion hole, the method comprising:
(a) a step of judging whether a pressure in an insulation-displacement period where said insulation-displacement part is insulation-displaced to said wire satisfies the preset condition or not, and determining the defect state when judged not satisfying the condition;
(b) a step of judging whether a pressure in an intermediate period between said insulation-displacement period and a press-fitting period where said press-fitting part is press-fitted to said press-fitted part satisfies the preset condition, and determining the defect state when judged not satisfying the condition; and
(c) a step of judging whether a pressure in said press-fitting period satisfies the preset condition, and determining the defect state when judged not satisfying the condition.

2. The terminal insertion defect determining method according to claim 1, wherein
in said step (a), whether a maximum value of the pressure in said insulation-displacement period satisfies the preset insulation-displacement period threshold value condition or not is judged, and the defect state is determined when judged not satisfying said insulation-displacement period threshold value condition,
in said step (b), whether a minimum value of the pressure in said intermediate period satisfies the preset intermediate period threshold value condition or not is judged, and the defect state is determined when judged not satisfying said intermediate period threshold value condition, and
in said step (c), whether a maximum value of the pressure in said press-fitting period satisfies the preset press-fitting period threshold value condition or not is judged, and the defect state is determined when judged not satisfying said press-fitting period threshold value condition.

3. The terminal insertion defect determining method according to claim 2, wherein
an insulation-displacement period lower threshold value to be satisfied by the maximum value of the pressure in said insulation-displacement period is set as said insulation-displacement period threshold value condition in said step (a),
an intermediate period upper threshold value to be satisfied by the minimum value of the pressure in said intermediate period is set as said intermediate period threshold value condition in said step (b), and
a press-fitting period lower threshold value to be satisfied by the maximum value of the pressure in said press-fitting period is set as the press-fitting period threshold value condition in said step (c).

4. The terminal insertion defect determining method according to claim 3, wherein
in said step (a), when the maximum value of the pressure in said insulation-displacement period is judged not satisfying said insulation-displacement period lower threshold value, it is determined that wire or terminal is absent,
in said step (b), when the minimum value of the pressure in said intermediate period is judged not satisfying said intermediate period upper threshold value, it is determined to be terminal displacement, and
in said step (c), when the maximum value of the pressure in said press-fitting period is judged not satisfying said press-fitting period lower threshold value, it is determined to be a shortage of press-fitting.

5. The terminal insertion defect determining method according to claim 3, wherein the press-fitting period upper threshold value to be satisfied by the maximum value of the pressure in said press-fitting period is further set as the press-fitting period threshold value condition in said step (c).

6. The terminal insertion defect determining method according to claim 5, wherein
in said step (a), when the maximum value of the pressure in said insulation-displacement period is judged not satisfying said insulation-displacement period lower threshold value, it is determined that wire or terminal is absent,
in said step (b), when the minimum value of the pressure in said intermediate period is judged not satisfying said intermediate period upper threshold value, it is determined to be terminal displacement, and
in said step (c), when the maximum value of the pressure in said press-fitting period is judged not satisfying said press-fitting period lower threshold value, it is determined to be a shortage of press-fitting, and when judged not satisfying said press-fitting period upper threshold value, it is determined to be an excess of press-fitting.

7. The terminal insertion defect determining method according to claim 1, further comprising (d) a step of obtaining a timing at which the maximum value of the pressure applied on said insulation-displacement terminal is produced in said insulation-displacement period, and judging whether said timing is in a period determined in accordance with displacement of said insulation-displacement terminal or not, determining to be an abnormal wire position when said timing is not in the period.
